(19) United States
(12) Patent Application Publication
(10) Pub. No.: US 2024/0123450 A1
(43) Pub. Date: Apr. 18, 2024

(54) LID ASSEMBLY FOR A SAMPLE TUBE, METHOD OF USING THE SAME TO COLLECT MAGNETIC BEADS, AND SAMPLE PROCESSING KIT

(71) Applicant: IMPERIAL COLLEGE INNOVATIONS LIMITED, London (GB)

(72) Inventors: Matthew L. CAVUTO, London (GB); Ivana PENNISI, London (GB); Jesus RODRIGUEZ MANZANO, London (GB); Pantelis GEORGIOU, London (GB)

(21) Appl. No.: 18/278,212

(22) PCT Filed: Feb. 21, 2022
(86) PCT No.: PCT/GB2022/050464

§ 371 Date: Aug. 22, 2023

(30) Foreign Application Priority Data
Feb. 23, 2021 (GB) 2102573.9

(51) Int. Cl. B01L 3/00; B01L 1/00; B01L 9/06; B03C 1/28

(52) U.S. Cl. CPC B01L 3/50825; B01L 1/52; B01L 9/06; B03C 1/286; B01L 2200/0668; B01L 2300/047; B01L 2300/069; B01L 2400/043; B03C 2201/18

(57) ABSTRACT

A lid assembly for a sample tube, for collecting magnetic beads from the sample tube and subsequently releasing said beads, the lid assembly comprising: a closure part including means for removably attaching the closure part to the opening of the sample tube, to close the sample tube, and a bead-collecting platform arranged to locate within or above the opening of the sample tube when the closure part is attached to the sample tube, wherein the bead-collecting platform has a bead-collecting surface on one side, for coming into contact with liquid in the sample tube during use, and a magnet-receiving cavity on the other side, behind the bead-collecting surface; and a magnet-bearing part comprising a magnet, wherein the magnet is removably insertable into the magnet-receiving cavity, towards the bead-collecting surface, such that, when the magnet is present within the magnet-receiving cavity, the magnet is capable of holding magnetic beads against the bead-collecting surface, and when the magnet is not present within the magnet-receiving cavity, the lid assembly is incapable of magnetically holding magnetic beads against the bead-collecting surface. Also provided is a method of using such apparatus to collect magnetic beads from a liquid within a sample tube, and associated kits and accessories.

This invention was made with US government support under Award Number R01A1128765 awarded by the National Institute of Allergy and Infectious Diseases of the National Institutes of Health. The US government has certain rights in the invention.

### FIELD OF THE INVENTION

This invention relates to a lid assembly for a sample tube, that is adapted to collect magnetic beads from a liquid within the sample tube, and to an associated method of using such apparatus. The apparatus and method are particularly suitable for, but by no means limited to, performing extraction of targeted biomolecules from a solid or liquid sample using magnetic separation. A sample processing kit including such apparatus is also provided, along with some accessories.

The term “magnetic beads” as used herein should be interpreted broadly. Firstly, the term “magnetic” should be interpreted broadly, to encompass “paramagnetic”. Moreover, the term “beads” should also be interpreted broadly, to encompass particles of a range of sizes, including nanoparticles (i.e. particles that are less than 1 μm in diameter), micron-sized particles (i.e. of the order of 1-500 μm in diameter), and larger particles (potentially up to around 1 mm or so in diameter). As those skilled in the art will appreciate, the principles of the present disclosure are not limited to any particular size or composition of the magnetic “beads”, and for any given application it will be understood that the skilled person will use beads of a suitable size and composition.

### BACKGROUND TO THE INVENTION

Magnetic separation, using magnetic beads, is an established technique for extracting targeted biomolecules from a sample.

Magnetic beads typically consist of two components: a magnetic material (often iron, nickel or cobalt) and a chemical component that provides functionality to the beads, thereby enabling the beads to attach to biomolecules or other chemical or biological species. Such species may include, but are not limited to, polynucleotides such as nucleic acid (e.g. RNA or DNA), proteins, biological cells, and other chemical or biological molecules.

The principles of magnetic bead extraction are well established and outlined for example in U.S. Pat. Nos. 4,554,088 and 5,705,628, which themselves reference further background art in respect of this technique.

More recently, US 2015/0196905 A1 has proposed a centrifugable liquid vessel integrating a magnet in its lid, for the separation of magnetic beads in suspension in a liquid and comprising four detachable components: a centrifugable liquid vessel, a small removable magnet, a hollow cylindrical connector cap and an opened lid adapter. In use, the components are attached together by means of screw threads.

The fact that the vessel in US 2015/0196905 A1 is specifically centrifugable suggests that, in practice, centrifugation may often be necessary for it to satisfactorily perform its intended function. However, use of a centrifuge restricts the use of the vessel to a laboratory or at least a location at which electrical power is available. This renders the vessel unsuitable for use in field locations that lack a source of electrical power or where use of a centrifuge is not possible.

Other potential shortcomings of the apparatus disclosed in US 2015/0196905 A1 are that the use of screw threads between the components is considered to render the apparatus somewhat awkward and time consuming to use. Indeed, the constituent components do not appear to lend themselves to quick and easy use, which in turn leads to an increased risk of contamination of the magnetic beads, particularly when transferring them between vessels.

There is therefore a need for apparatus that addresses at least some of the above problems, to enable a rapid, simple, low-cost and electrical-power-free extraction process to be carried out in respect of targeted biomolecules from a sample using magnetic beads.

### SUMMARY OF THE INVENTION

According to a first aspect of the present invention there is provided a lid assembly as defined in Claim 1 of the appended claims.

Thus there is provided a lid assembly for a sample tube, for collecting magnetic beads from the sample tube and subsequently releasing said beads, the lid assembly comprising: a closure part including means for removably attaching the closure part to the opening of the sample tube, to close the sample tube, and a bead-collecting platform arranged to locate within or above the opening of the sample tube when the closure part is attached to the sample tube, wherein the bead-collecting platform has a bead-collecting surface on one side, for coming into contact with liquid in the sample tube during use, and a magnet-receiving cavity on the other side, behind the bead-collecting surface; and a magnet-bearing part comprising a magnet, wherein the magnet is removably insertable into the magnet-receiving cavity, towards the bead-collecting surface, such that, when the magnet is present within the magnet-receiving cavity, the magnet is capable of holding magnetic beads against the bead-collecting surface, and when the magnet is not present within the magnet-receiving cavity, the lid assembly is incapable of magnetically holding magnetic beads against the bead-collecting surface.

As those skilled in the art will appreciate from the present disclosure, the term “sample tube” as used herein should be interpreted broadly, to encompass any appropriate tube that may be used for containing or processing a sample or a derivative of a sample.

By virtue of the magnet being removably insertable into the magnet-receiving cavity, the state of the lid assembly can quickly and easily be changed from a state in which magnetic beads are attracted onto the bead-collecting surface, to a state in which any such beads would be released, without requiring the use of electrical power.

This also lends the apparatus well to use in remote field locations, without specialist training being necessary.

Moreover, as described herein, by virtue of being platform-like, the bead-collecting platform may advantageously hold collected magnetic beads in a manner whereby they are substantially exposed to surrounding air, when the lid assembly is removed from the sample tube, thus aiding the drying of the collected beads in use.

In a presently-preferred embodiment the magnet-bearing part is entirely separable from the closure part, thereby making the device simple to use, and straightforward and inexpensive to manufacture, and therefore readily deliverable to end-users.

However, in other variants the magnet-bearing part may be coupled to the closure part whilst permitting the magnet to be moved within the magnet-receiving cavity, towards or away from the bead-collecting surface.

Preferably the magnet-bearing part further comprises a user-grippable part to which the magnet is attached, thereby facilitating manipulation and insertion of the magnet into the magnet-receiving cavity, and subsequent removal of the magnet from the magnet-receiving cavity, by the user.

The user-grippable part may have a relatively thin and planar shape, enabling it to be easily gripped between the user's thumb and forefinger. Alternatively, the user-grippable part may have a cross-sectional profile such as to enable it to act as a stand, for supporting the magnet-bearing part upside-down (optionally with the closure part and sample tube attached).

The magnet-receiving cavity may be in the form of a socket shaped to receive at least the magnet of the magnet-bearing part.

Optionally the magnet-bearing part may be rotatable within the socket.

In certain embodiments the magnet-bearing part and the closure part may be mutually engageable when the magnet is inserted into the magnet-receiving cavity.

Accordingly, the magnet may be reversibly locked into place in the magnet-receiving cavity, thereby reliably maintaining the bead-attracting state of the lid assembly and preventing the magnet-bearing part from accidentally falling out. This may be particularly beneficial when inverting the sample tube with the lid assembly attached, or using the lid assembly to transport magnetic beads from one sample tube to another.

For example, the magnet-bearing part may optionally comprise one or more radial protrusions and the socket may comprise one or more complementary channels into which the one or more radial protrusions are engageable. Alternatively the magnet-bearing part and the socket may comprise mutually-engageable threads.

Alternatively, or in addition, the socket may comprise gripping means (e.g. protrusions or ridges) for gripping the magnet-bearing part.

Advantageously, for the sake of rapid and simple use, the means for removably attaching the closure part to the opening of the sample tube may comprise a press-fit part adapted to engage with the opening of the sample tube. In the presently-preferred embodiment the press-fit part is the bead-collecting platform.

In alternative embodiments, the means for removably attaching the closure part to the opening of the sample tube may comprise a snap-fit mechanism.

In various embodiments the closure part, when viewed from above, may have an elongate shape, as this has been found to work well in conjunction with sample tubes having hinged caps.

The closure part may comprise first and second finger-tabs (optionally having concave or textured outer surfaces) on opposite sides of the closure part, to enable it to be gripped by a user's thumb and finger in use.

In certain embodiments the first and second finger-tabs extend below the bead-collecting surface and can act as a stand for supporting the lid assembly in an upright orientation when separated from the closure part.

Alternatively, or in addition, the first and second finger-tabs may extend above the bead-collecting surface and can act as a stand for supporting the lid assembly (optionally with a sample tube attached) in an upside-down orientation.

The bead-collecting platform may extend parallel to, and separate from, the first and second finger-tabs. Amongst other things, such a configuration promotes airflow around the bead-collecting platform when the lid assembly is removed from the sample tube, thus enhancing the drying of any magnetic beads collected thereon (such beads being substantially exposed to the air), whilst also shielding the bead-collecting surface from accidental contact by the user's fingers.

Optionally the bead-collecting surface may incorporate a recessed or concave region, to promote collection of magnetic beads thereon. Alternatively the bead-collecting surface may be convex, to aid the drying of collected magnetic beads.

Alternatively, or in addition, the bead-collecting surface may incorporate an array of depressions or recesses, to promote a uniform distribution of magnetic beads across the bead-collecting surface.

Optionally the bead-collecting surface incorporates a fluid wicking member (e.g. a wicking spike), to enhance the removal of liquid from the bead-collecting surface.

According to a second aspect of the invention there is provided a kit comprising a lid assembly according to the first aspect of the invention, at least a first sample tube, and optionally a pipette, and/or a swab, and/or a further sample collection tube.

In one embodiment the kit may have a plurality of sample tubes connected to each other, e.g. side by side, to facilitate use of the tubes in a required sequence.

Optionally a last of the sample tubes may be connected to its neighbouring sample tube by a frangible connection, to enable subsequent processing of the contents of the last tube away from the other tubes.

In certain embodiments the kit may have first, second and third sample tubes. For example, the first sample tube may contain a lysis/binding buffer liquid, the second sample tube may contain a washing liquid, and the third sample tube may contain an elution liquid. The tubes in the kit may be prefilled with such liquids. Additionally, or alternatively, the first sample tube may be preloaded with magnetic beads. Alternatively, however, the magnetic beads may be provided in a separate container, sachet, blister pack, blow-fill-seal tube, or such like.

Advantageously the packaging for the kit (containing the sample tube(s), lid assembly, and optionally other components) may be configured to act as a stand/station for the contents of the kit during use, thereby replacing additional laboratory equipment such as a tube rack. More particularly, the kit may comprise a tray that incorporates one or more recesses or cavities for supporting the sample tube(s), and a recess on which the lid assembly is placed. Thus, the packaging may provide a dedicated area in which to place the/each tube in-between processing steps, and a dedicated space in which the lid assembly may be placed to allow liquid to evaporate from the magnetic beads held against the bead-collecting surface. The packaging may also provide a dedicated space in which a sample collection/swab tube may remain during the extraction procedure, thus effectively linking the sample with the extraction kit. The packaging may also include a cover that is able to serve as a waste receptacle for the sample tubes and other contents of the kit, once they have been used, or as a temporary staging area.

According to a third aspect of the invention there is provided a sample tube with a closable cap, wherein the cap comprises a compartment containing a reagent, and wherein the compartment has a removable cover for sealing the reagent therein. In particular, the compartment may be on the inside of the cap, such that the compartment locates within the sample tube when the cap closes the sample tube. By virtue of this cap compartment, such a tube facilitates the introduction of a predetermined quantity of a predetermined reagent into the liquid in the sample tube. The reagent may be wet and/or lyophilised, and may for example be used for amplification, detection or biosensing of extracted analytes present within the liquid in the sample tube.

The cap may be attached to the tube by a flexible hinge.

In some embodiments the reagent may be in the form of a bead, thereby facilitating loading of the reagent into the compartment, and enabling the entirety of the reagent, as one, to exit the compartment and pass into the tube, e.g. by dropping out of the compartment. In other embodiments, however, the bead may be press-fitted into the compartment, to prevent it from dropping out by accident.

In certain embodiments the reagent may be a lyophilized colorimetric detection reagent. As those skilled in the art will appreciate, in other embodiments the reagent may be lyophilised and not colorimetric, whereas in yet further embodiments the reagent may be neither lyophilised nor colorimetric. Thus, more generally, the reagent may be any suitable detection reagent.

The kit of the above-described second aspect may comprise at least one sample tube according to the third aspect—in particular to serve as the third sample tube mentioned above.

According to a fourth aspect of the invention there is provided a method of collecting magnetic beads from a liquid within a sample tube (in which liquid the beads may be suspended), the method comprising:
attaching the closure part of an above-described lid assembly to the opening of the sample tube; and
agitating (e.g. gently shaking or inverting) the liquid with the magnet inserted in the magnet-receiving cavity, such that the magnetic beads come into contact with the bead-collecting surface and are held by the magnet against the bead-collecting surface.

Such a process is quick and easy to perform, and does not require the use of electricity, a centrifuge, or specialist training.

The sample tube may be a first sample tube containing a first liquid, and the method may further comprise:
detaching the lid assembly from the first sample tube, with the magnet inserted in the magnet-receiving cavity and the magnetic beads held by the magnet against the bead-collecting surface;
attaching the closure part of the lid assembly to the opening of a second sample tube containing a second liquid; and
removing the magnet from the magnet-receiving cavity, such that the magnetic beads are no longer held by the magnet against the bead-collecting surface and become suspended in the second liquid.

Thus, this enables the magnetic beads to be quickly and easily transferred from the first liquid in the first sample tube to the second liquid in the second sample tube, by means of the lid assembly.

Moreover, to transfer the beads further, the method may further comprise:
reinserting the magnet in the magnet-receiving cavity (with the closure part of the lid assembly still being attached to the opening of the second sample tube);
agitating the second liquid such that the magnetic beads come into contact with the bead-collecting surface and are held by the magnet against the bead-collecting surface;
detaching the lid assembly from the second sample tube, with the magnet inserted in the magnet-receiving cavity and the magnetic beads held by the magnet against the bead-collecting surface;
attaching the closure part of the lid assembly to the opening of a third sample tube containing a third liquid; and
removing the magnet from the magnet-receiving cavity, such that the magnetic beads are no longer held by the magnet against the bead-collecting surface and become suspended in the third liquid.

Optionally, to finally remove the magnetic beads from the third liquid, the method may further comprise:
reinserting the magnet in the magnet-receiving cavity (with the closure part of the lid assembly still being attached to the opening of the third sample tube);
agitating the third liquid such that the magnetic beads come into contact with the bead-collecting surface and are held by the magnet against the bead-collecting surface; and
detaching the lid assembly from the third sample tube, with the magnet inserted in the magnet-receiving cavity and the magnetic beads held by the magnet against the bead-collecting surface;
and then optionally disposing of the lid assembly and/or the magnetic beads.

In particular practical implementations the method may be for the extraction of targeted biomolecules (such as the characteristic nucleic acids (e.g. RNA or DNA) of a particular virus—for example, but not limited to, SARS-CoV-2), wherein:
the first liquid is a lysis/binding buffer liquid, for lysing the targeted biomolecules and thereby releasing them into solution, and binding the biomolecules to the magnetic beads;
the second liquid is a washing liquid; and
the third liquid is an elution liquid, for eluting the biomolecules.

Thus, the targeted biomolecules may comprise nucleic acid.

The method may further comprise introducing a detection reagent (e.g. a colorimetric detection reagent) into the elution liquid, and applying heating if necessary, to determine the presence or absence of the targeted biomolecules.

The third sample tube (containing the elution liquid) may be a sample tube according to the above-described third aspect, wherein the reagent held in the cap compartment is a detection reagent, and wherein introducing the detection reagent into the elution liquid comprises releasing it from the cap compartment of the sample tube.

It will be appreciated that methods based around the present principles may employ a number of sample tubes other than three, and any number of processing steps as required for the extraction of a particular biomolecule.

According to a fifth aspect of the invention there is provided a handheld device for holding a plurality of sample tubes and enabling them to be simultaneously manually agitated or inverted, the device comprising: a handle part; and a plurality of sample tube retaining clips, each for holding a respective sample tube.

The device may further comprise a plurality of restraining arms, each restraining arm extending above a respective one of the retaining clips, for preventing the sample tubes from falling out of the retaining clips when the device is inverted. Each restraining arm may be offset to one side of the respective retaining clip.

According to a sixth aspect of the invention there is provided a method of simultaneously manually agitating or inverting a plurality of sample tubes, comprising inserting the sample tubes into the device according to the fifth aspect, and manipulating the handle part.

Optionally, at least one of the sample tubes may be attached to a lid assembly according to the first aspect. Also optionally, at least one of the sample tubes may be a sample tube according to the third aspect.

### BRIEF DESCRIPTION OF THE DRAWINGS

Embodiments of the invention will now be described, by way of example only, and with reference to the drawings in which:

FIG. 1 illustrates (a) a perspective view of a lid assembly for a sample tube, comprising a magnet-bearing part engaged with a closure part; (b) a perspective view of the magnet-bearing part, having a user-grippable part to which a magnet is attached; (c) an exploded view of the magnet-bearing part; and (d) a perspective view of the closure part, which includes first and second finger-tabs, a bead-collecting platform and a magnet-receiving cavity in the form of a socket;

FIG. 2 is a perspective view of the underside of the closure part of FIG. 1, showing a bead-collecting surface on the underside of the bead-collecting platform, and an optional wicking member (in this case a central wicking spike);

FIG. 3 is a perspective view of the underside of a variant of the closure part of FIG. 2, not having the optional wicking member;

FIG. 4 is a view of the lid assembly of FIG. 1 laid on its side, without magnetic beads present on the bead-collecting surface;

FIG. 5 is a view of the lid assembly of FIG. 1 laid on its side, as in FIG. 4, but with magnetic beads present on the bead-collecting surface;

FIG. 6 is a side view of the lid assembly of FIG. 1, showing magnetic beads being held against the bead-collecting surface by the magnet of the magnet-bearing part;

FIG. 7 illustrates the process of disengaging and separating the magnet-bearing part of FIG. 1 from the respective closure part;

FIG. 8 illustrates the lid assembly of FIG. 1 and a sample tube, and the process of attaching the closure part to the opening of the sample tube;

FIG. 9 further illustrates the lid assembly of FIG. 1 being attached to the sample tube of FIG. 8;

FIG. 10 illustrates the process of disengaging and separating the magnet-bearing part of the lid assembly of FIG. 8 from the respective closure part, with the closure part remaining attached to the sample tube;

FIG. 11 is a cross-sectional side view of (a) the disengagement process, and (b) the separation process, of FIG. 10;

FIG. 12 is a perspective view of a kit comprising the lid assembly of FIG. 1, three sample tubes and a pipette (in this case, an exact volume pipette);

FIG. 13 is a perspective view of a variant of the kit of FIG. 12, comprising a further sample collection tube;

FIG. 14 shows further perspective views of a kit as in FIG. 12 or FIG. 13, with a cover and a backing panel;

FIG. 15 is a perspective view of three sample tubes connected together, along with the lid assembly of FIG. 1;

FIG. 16 illustrates steps (a)-(l) of a method of collecting magnetic beads from a first liquid in a first sample tube, and subsequently transferring the beads to a second liquid in a second sample tube;

FIG. 17 illustrates a variant of the lid assembly of FIG. 1, by means of (a) a perspective view, (b) a cutaway view of the closure part, and (c) a plan view of the closure part, showing that, in this case, the magnet-receiving cavity comprises gripping ridges for gripping the magnet-bearing part;

FIG. 18 illustrates (a) a cross-sectional engaged view, and (b) a perspective disengaged view, of another variant of the lid assembly of FIG. 1, wherein the magnet-bearing part and the socket comprise mutually-engageable threads;

FIG. 19 illustrates a variant of the lid assembly of FIG. 1, wherein the first and second finger-tabs of the closure part are arranged to act as a stand for supporting the lid assembly upside-down, with a sample tube attached;

FIG. 20 illustrates another variant of the lid assembly of FIG. 1, attached to a sample tube, wherein the user-grippable part of the magnet-bearing part is configured to act as a stand for supporting the lid assembly and the attached sample tube in an upside-down orientation;

FIG. 21 shows perspective views of a sample tube with a closable cap, wherein the cap comprises a compartment having a removable cover and containing a reagent bead;

FIG. 22 illustrates (a) perspective cross-sectional and (b) cross-sectional views of the sample tube of FIG. 21;

FIG. 23 illustrates a method of using the sample tube of FIG. 21, wherein a reagent bead is released into liquid within the sample tube to perform colorimetric analysis, to determine the presence or absence of a targeted species in the liquid; and

FIG. 24 is a perspective view of a handheld device for holding a plurality of sample tubes and enabling them to be simultaneously manually agitated or inverted, with one such sample tube in place with the lid assembly of FIG. 1 attached.

In the figures, like elements are indicated by like reference numerals throughout.

### DETAILED DESCRIPTION OF PREFERRED EMBODIMENTS

The present embodiments represent the best ways known to the Applicant of putting the invention into practice. However, they are not the only ways in which this can be achieved.

### Overview

The present disclosure enables a rapid, low-cost and electrical-power-free extraction process to be carried out in respect of targeted biomolecules from a liquid (or solid) sample. The targeted biomolecules may be polynucleotides, such as nucleic acid (e.g. RNA or DNA). For example, the targeted biomolecule may be the characteristic RNA of a particular virus, such as, but not limited to, SARS-CoV-2.

The process does not require any expensive laboratory equipment (such as a centrifuge, vortex mixer or micropipettes), a source of electrical power, or detailed prior training, and can be carried out in practically any location (i.e. away from a laboratory), such as at a point of care. The whole process from initial sample (such as swab, saliva, tissue or blood) to extracted biomolecule (e.g. protein, RNA or DNA) can be performed in under five minutes by a substantially untrained user. The process is based on magnetic separation, using magnetic beads (where the term “magnetic beads” should be interpreted broadly, as outlined above). The principles of the present extraction process are similar to those of other magnetic bead extraction kits, and are not restricted to any particular size or composition of the magnetic beads. Indeed, for any given application it will be understood that the skilled person will use beads of a suitable size and composition.

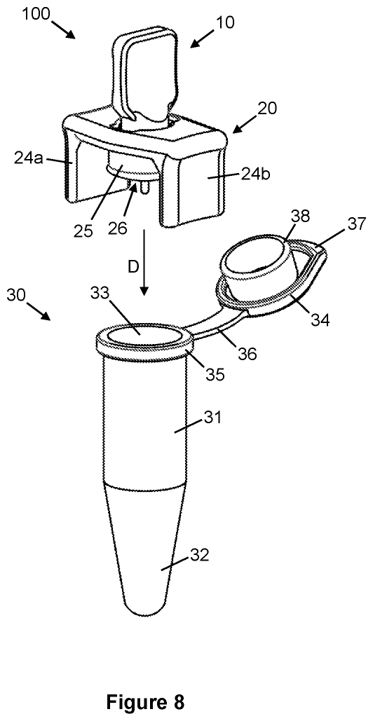

Turning initially to FIG. 8, the present disclosure provides a lid assembly 100 for a sample tube 30. The sample tube 30 may be a pre-existing sample tube, such as those manufactured by Eppendorf AG and generally referred to as Eppendorf Tubes (RTM), and the illustrated tubes, having hinged caps, are based on those. However, it should be noted that the principles of the present disclosure are in no way limited to use with Eppendorf Tubes (RTM), and may be applied to sample tubes of different geometries and dimensions, including tubes that do not have hinged caps. That said, practical implementations of the present lid assembly 100 are designed to fit specific diameters of sample tubes, although there is no restriction (within reason) as to the sample tube diameters with which implementations of the lid assembly 100 may be shaped to fit. Typically such sample tubes are of the order of a few centimetres in length, around one centimetre in diameter, and have a capacity of the order of 0.5-2 millilitres or so. In use, the sample tube 30 contains a liquid in which magnetic beads are suspended. The lid assembly 100 can be used to collect the magnetic beads from the liquid, and to subsequently release the beads, typically into a different tube containing a different liquid.

As will be discussed in detail below, the lid assembly 100 comprises two main parts, namely a closure part 20 and a magnet-bearing part 10. The magnet-bearing part 10 is reversibly removable from the closure part 20 and incorporates a magnet, which in our presently-preferred embodiments is a neodymium magnet, although other magnetic materials may be used instead. The closure part 20 has a bead-collecting surface 26. In use, to cause magnetic beads to be extracted from the liquid in the sample tube 30 and captured by the bead-collecting surface 26, the magnet-bearing part 10 is introduced into a magnet-receiving cavity within the closure part 20, thereby positioning the magnet behind the bead-collecting surface 26. With the magnet in this position (and, in practice, typically following gentle inversion of the tube) the magnetic beads in the sample tube 30 are attracted by the magnet and held against the bead-collecting surface 26, under the influence of the magnet's magnetic field. Subsequently, the magnetic beads can be released from the bead-collecting surface 26 by removing the magnet-bearing part 10 from the closure part 20 and thereby taking away the magnetic field.

The lid assembly 100, when viewed from above, may typically have a footprint of around 2-3 centimetres by about 1-2 centimetres, and its overall height (when the magnet-bearing part 10 is attached to the closure part 20) may be roughly 2-4 centimetres, although these measurements are merely approximate and by way of example only. In any given case, the dimensions of the lid assembly 100 will depend on the dimensions of the sample tube 30 to which it is designed to fit. The dimensions of the lid assembly 100 may also be designed to suit different hand sizes of users. Thus, the lid assembly 100 may be made in a range of different sizes, to suit different sample tubes and to be convenient and comfortable for different users. In the following, the lid assembly 100 will first be described in detail, including the mechanism and method by which the magnet-bearing part 10 is inserted into and engaged with the closure part 20. Then the manner by which the lid assembly 100 may be attached to, and used with, a sample tube 30 will be explained. Some sample processing kits containing the lid assembly 100 and sample tubes 30 will then be presented, followed by methods of using the present apparatus, e.g. to perform extraction of targeted biomolecules from a solid or liquid sample using magnetic separation. Finally, some variants of the present apparatus, and accessories, will be described.

### Lid Assembly

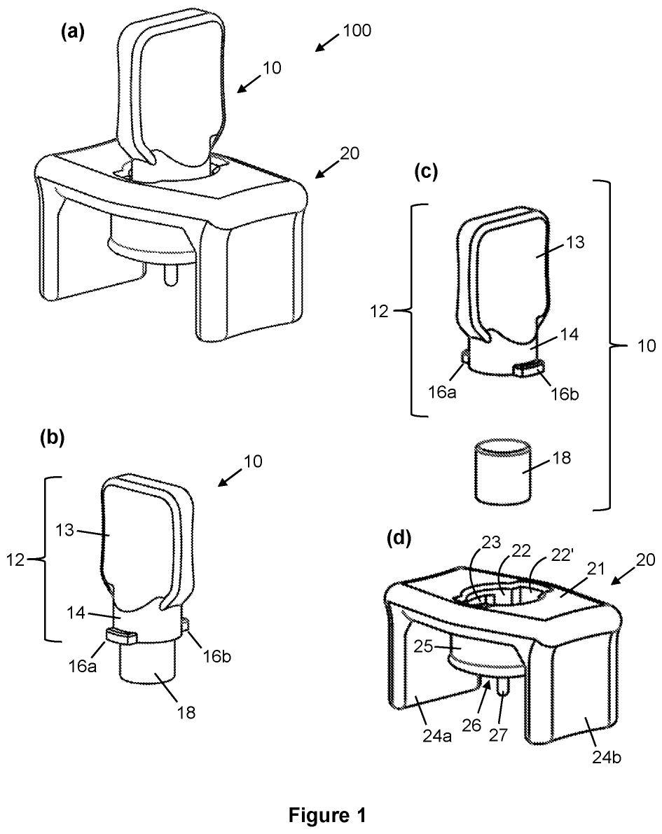

With reference first to FIG. 1, an example of a lid assembly 100 according to the present disclosure will now be described in detail.

FIG. 1(a) illustrates the lid assembly 100, with the magnet-bearing part 10 engaged with the closure part 20.

Magnet-Bearing Part 10

FIG. 1(b) illustrates the magnet-bearing part 10 in isolation, e.g. having been removed from (or not yet inserted into) the closure part 20, and FIG. 1(c) is an exploded diagram of the same component. The magnet-bearing part 10 comprises a magnet 18, which advantageously may be a neodymium magnet, although other magnetic materials may be used instead. In the illustrated example the magnet 18 is cylindrical in shape, although different shapes are also possible.

The magnet-bearing part 10 further comprises a body part 12, which may be made of a plastics material (e.g. by injection moulding or 3D printing). The magnet 18 is attached to the body part 12, e.g. by means of adhesive. A recess may be provided on the underside of the body part 12 to receive the magnet 18 and accurately align it for attachment. In other variants the recess and magnet 18 may be configured to engage with one another in a press-fit manner, thereby eliminating the need for adhesive to hold the magnet in place. Alternatively the magnet 18 may have the body part 12 overmoulded around it, thus fusing the magnet entirely inside the body part 12.

The body part 12 primarily comprises a user-grippable part 13 that the user can grip, typically between thumb and forefinger, to manipulate the magnet-bearing part 10 in use.

In the illustrated example of the magnet-bearing part 10, a lower region of the body part 12, between the user-grippable part 13 and the magnet 18, is in the form of a cylindrical shaft 14 having first and second radial protrusions 16a, 16b. As will be described further below, the cylindrical shaft 14 and the radial protrusions 16a, 16b enable the magnet-bearing part 10 to be rotatably engaged with the closure part 20.

Closure Part 20

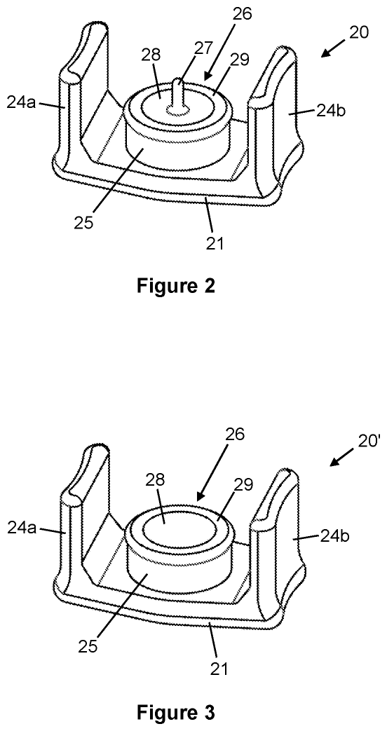

FIGS. 1(d) and 2 illustrate the closure part 20 in isolation. The closure part 20 may be made of a plastics material (e.g. by injection moulding or 3D printing) and comprises an upper part 21 (that is flat or substantially flat), first and second finger-tabs 24a, 24b by which the closure part can be gripped and manipulated by a user in use, and a central bead-collecting platform 25 which extends downwards from the upper part 21. Optionally the finger-tabs 24a, 24b may have concave or textured outer surfaces to enhance grip by the user. It will be appreciated that the term “upper” (and likewise “above”) is in the context of the closure part 20 being in the orientation shown in FIGS. 1 and 8, i.e. as at the time of fitting the closure part 20 to the sample tube 30, whereas “lower” (and likewise “below”) are in the opposite direction relative to “upper” and “above”.

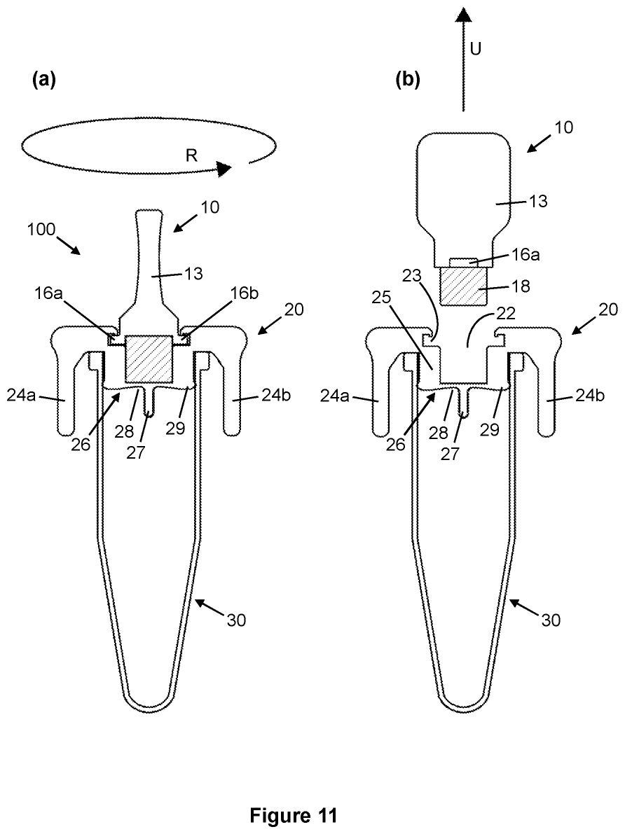

The bead-collecting platform 25 has a bead-collecting surface 26 on one side, and a magnet-receiving cavity 22 on the other side, both aligned with the centre of the closure part 20. The bead-collecting platform 25 is arranged to locate within (or potentially, in alternative embodiments, just above) the opening of a sample tube 30 when the closure part 20 is attached to the sample tube 30, such that the bead-collecting surface 26 is contactable by the liquid in the sample tube 30 during use. The magnet-receiving cavity 22 extends behind the bead-collecting surface 26 (as shown in cross-section in FIG. 11), substantially in the form of a cylindrical (axial) socket, and its primary function is to receive, when required, the magnet 18 of the magnet-bearing part 10.

Accordingly, the magnet-bearing part 10—in particular the magnet 18—is removably insertable into the magnet-receiving cavity 22, towards the bead-collecting surface 26. The cylindrical shape (i.e. circular cross-section) of both the magnet 18 and the shaft 14 of the magnet-bearing part 10 permit the magnet-bearing part 10 to be inserted downwards and also rotated within the cavity 22.

In the illustrated example, the magnet-receiving cavity 22 further comprises a pair of opposing longitudinal channels 22′ shaped to accommodate the radial protrusions 16a, 16b of the magnet-bearing part 10, and a pair of circumferential channels 23 into which the radial protrusions 16a, 16b can be rotated into engagement, broadly in the manner of an unsprung bayonet mount, once the magnet 18 has been fully inserted into the cavity 22.

Thus, the magnet-bearing part 10 is first inserted into the magnet-receiving cavity 22 in a linear (non-rotational) manner, with the radial protrusions 16a, 16b aligned with the longitudinal channels 22′. Then, once the magnet 18 is fully inserted into the cavity 22, the user can engage the magnet-bearing part 10 with the closure part 20 by rotating the magnet-bearing part 10 relative to the closure part 20 such that the radial protrusions 16a, 16b move along the circumferential channels 23. In the illustrated example the magnet-bearing part 10 is rotated in a clockwise manner relative to the closure part 20, when viewed from above, to perform the engagement process.

As illustrated, the circumferential channels 23 may each extend 90° around the circumference of the cavity 22, such that the radial protrusions 16a, 16b reach a stop once the magnet-bearing part 10 has been rotated through 90° relative to the closure part 20. The circumferential channels 23 may incorporate dimples or a detent (or click) mechanism, so as to provide the user with tactile feedback as the radial protrusions 16a, 16b reach or approach the end of the respective circumferential channels 23, and/or to lightly and reversibly lock the protrusions 16a, 16b at the end (or near the end) of the circumferential channels 23. For instance, in one embodiment, the mechanism may provide the user with a “click” effect which occurs once the magnet-bearing part 10 has been rotated through 45° relative to the closure part 20. Such a “click” effect may be produced by small protrusions (one on each radial protrusion 16a/16b, and a respective one in each channel 23) passing each other and interfering briefly as the magnet-bearing part 10 is rotated.

Such manipulation of the magnet-bearing part 10 and the closure part 20 is performed by the user gripping the user-grippable part 13 of the magnet-bearing part 10 with one hand, and gripping the finger-tabs 24a, 24b of the closure part 20 with the other hand, and moving the magnet-bearing part 10 and the closure part 20 relative to one other.

FIG. 2 shows the underside of the closure part 20 of FIG. 1. It can be seen that the bead-collecting surface 26, on the underside of the bead-collecting platform 25, has a raised outer rim 29 (the diameter of which is slightly larger than the rest of the bead-collecting platform 25), a recessed or concave region 28 in which to collect magnetic beads in use, and an optional wicking member 27 in the centre—in this case in the form of a wicking spike.

The wicking spike 27 serves to prevent fluid carry-over and retention of liquid on the bead-collecting surface 26, especially in the event that the lid assembly 100 is being used to transfer magnetic beads from one sample tube to another (as, in such cases, it is generally undesirable to transfer any of the liquid from which the beads were collected). This effect is achieved by the wicking spike 27 breaking the surface tension of any such liquid and encouraging the liquid to wick down the spike 27 and off the closure part 20 and any beads held thereon. No centrifugation is required to achieve this effect.

FIG. 3 shows the underside of a variant 20′ of the closure part of FIG. 2. The variant 20′ is the same as that of FIG. 2, but without the optional wicking member. Accordingly, the closure part 20′ has a larger central recessed or concave region 28, potentially enabling a greater quantity of magnetic beads to be collected. Otherwise, the closure part 20′ has the same features and functionality as the closure part 20, and the two may be used interchangeably in practice. Thus, subsequent references to closure part 20 herein should be understood as encompassing the possibility of using closure part 20′ instead.

In alternative variants to those shown in FIGS. 2 and 3, the region 28 may have a convex (or domed) profile, rather than a concave profile. Such a convex (or domed) profile may speed up the drying of magnetic beads when collected on the surface, by giving the beads greater exposure to circulating ambient air.

With reference in passing to FIGS. 8 and 11, for example, the closure part 20 comprises means for removably attaching the closure part 20 to the opening of the sample tube 30, to close the sample tube 30. In the illustrated embodiment the means for removably attaching the closure part 20 to the opening of the sample tube 30 is provided by the bead-collecting platform 25, which is shaped to snugly fit into the opening of the sample tube 30 in a press-fit manner, broadly in the manner of a bung, thereby enabling quick and easy attachment (and subsequent detachment) of the lid assembly 100 to the sample tube 30.

Sealing of the closure part 20 with the opening of the sample tube 30 is also enhanced by the rim 29 of the bead-collecting surface 26 having a slightly larger diameter than the rest of the bead-collecting platform 25, so as to form a compression fit with the internal wall of the sample tube 30, essentially in a press-fit manner. Thus, the rim 29 advantageously provides two functions—to retain the magnetic beads within the recessed region 28 and to form a compression fit with the internal wall of the sample tube 30.

In other variants of the closure part 20, alternative means for removably attaching the closure part 20 to the opening of the sample tube 30 may be provided. For example, the closure part 20 may incorporate a snap-fit mechanism or a screw-thread arrangement, to engage with a complementary feature of the sample tube. It will be appreciated that the bead-collecting platform 25, which extends downwards from the centre of the upper part 21, has air all around it when the closure part 20 is not attached to a sample tube 30. Consequently, when detached from a sample tube, the bead-collecting surface 26 is able to hold magnetic beads 42 in a manner such that they are largely exposed to the air (although still shielded by the first and second finger-tabs 24a, 24b, which extend parallel to, yet separate from, the bead-collecting platform 25). This allows for any liquid on the beads to evaporate quickly, prior to resuspension of the beads into a subsequent liquid, thereby avoiding contamination of said subsequent liquid by the preceding liquid. Such evaporation typically takes only around 30 seconds, with no additional drying apparatus being required.

Moreover, when the bead-collecting surface 26 is inserted into a subsequent sample tube 30, the unobstructed nature of the bead-collecting surface 26 allows the magnetic beads 42 to be easily detached from the lid assembly 10 and resuspended in the liquid contained within that subsequent tube 30, through gentle shaking or inversion of the tube and without the magnet 18 present.

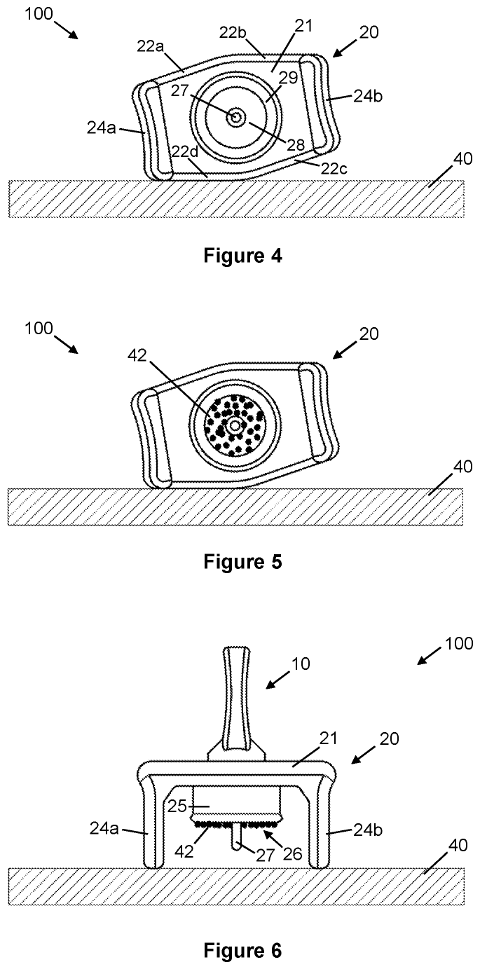

With reference to FIGS. 4, 5, 8 and 10, for example, the upper part 21 of the closure part 20 preferably has an elongate shape when viewed from above or below, to enable it to fit comfortably onto a sample tube 30 having a hinged cap 34 (see e.g. FIG. 8), without fouling the hinge 36 or the cap 34.

More particularly, as shown in FIGS. 4 and 5, the upper part 21 of the closure part 20, when viewed from above or below, may be substantially in the shape of an elongate irregular hexagon, having two opposing sides formed by the first and second finger-tabs 24a, 24b, and four further sides 22a, 22b, 22c, 22d. Sides 22a and 22b, and likewise sides 22c and 22d, meet at an obtuse angle. This enables the closure part 20, and indeed the overall lid assembly 100, to be laid on its side on a surface 40, as shown in FIGS. 4 and 5, without it rolling away. The illustrated elongate irregular hexagonal shape is merely one possible shape for the closure part, though, and other shapes are also feasible, such as a rectangle or a semicircle, for example.

FIGS. 5 and 6 are views of the lid assembly 100 of FIGS. 1, 2 and 4, with magnetic beads 42 present on the bead-collecting surface 26—specifically, within the recessed or concave region 28. The side view of FIG. 6 shows that the first and second finger-tabs 24a, 24b may also be used as a stand to support the lid assembly 100 upright on the surface 40 on which the lid assembly 100 has been stood. Accordingly, the first and second finger-tabs 24a, 24b extend below the bead-collecting surface 26 (and beyond the wicking member 27), so that the magnetic beads 42 are kept clear of the surface 40 and not contaminated by it.

Thus, the first and second finger-tabs 24a, 24b protect the magnetic beads 42 on the bead-collecting surface 26 from accidentally coming into contact with the surface 40 and (at least to some extent) the user's finger.

When the magnet 18 is present within (i.e. has been inserted into) the magnet-receiving cavity 22, the magnet 18 is capable of holding magnetic beads against the bead-collecting surface 26. That is to say, the bead-collecting surface 26 can be used to collect magnetic beads 42 that are suspended in a liquid within the sample tube 30. This happens as a result of the magnetic beads 42 being attracted towards the magnet 18 under the influence of the magnet's magnetic field, resulting in the beads 42 being held against the bead-collecting surface 26.

Conversely, when the magnet 18 is not present within (i.e. has not been inserted into, or has been removed from) the magnet-receiving cavity 22, the lid assembly 20 is incapable of magnetically holding magnetic beads against the bead-collecting surface 26, as the abovementioned magnetic field is not present to pull the beads against the bead-collecting surface 26. Accordingly, magnetic beads 42 held against the bead-collecting surface 26 can be released from the bead-collecting surface 26 by removing the magnet 18 from the magnet-receiving cavity 22.

In order to maximise the pulling effect of the magnet 18 (when inserted into the cavity 22) on the magnetic beads 42, to hold them against the bead-collecting surface 26, a strong magnet (i.e. one that produces a strong magnetic field) is preferably used, such as a neodymium magnet.

Removal of the Magnet-Bearing Part 10 from the Closure Part 20

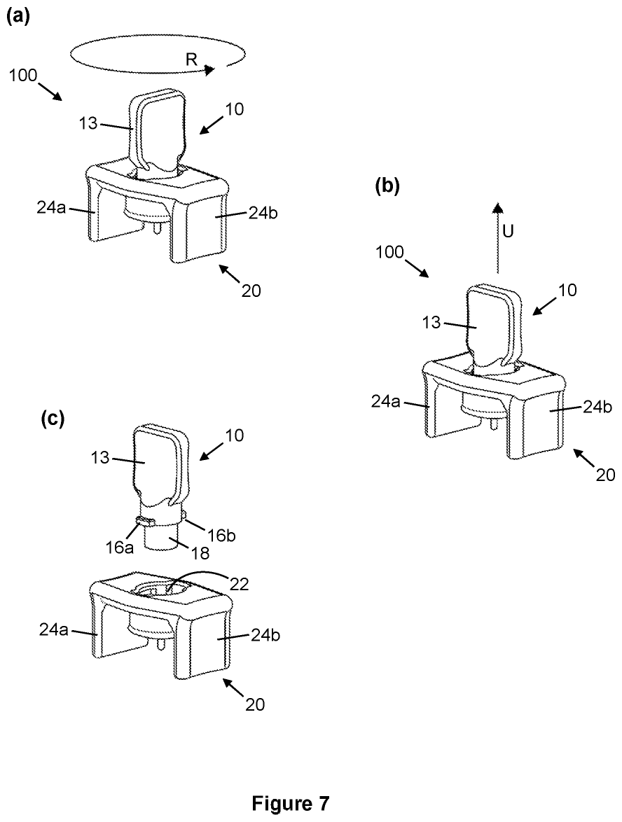

The magnet-bearing part 10 may be disengaged and separated from the closure part 20 by reversing the insertion and engagement process described above. Such a disengagement and separation process is illustrated FIG. 7. Firstly (a) the magnet-bearing part 10 is rotated anticlockwise 90° relative to the closure part 20, as per arrow R, to disengage the first and second radial protrusions 16a, 16b from their respective circumferential channels 23, and thus align the first and second radial protrusions 16a, 16b with their respective longitudinal channels 22′ (of FIG. 1(d)). Then (b) the magnet-bearing part 10 is lifted upwards, in the direction of arrow U, out of the magnet-receiving cavity 22. This results in (c) the magnet-bearing part 10 having been separated from the closure part 20. As above, such manipulation of the magnet-bearing part 10 and the closure part 20 is performed by the user gripping the user-grippable part 13 of the magnet-bearing part 10 with one hand, and gripping the finger-tabs 24a, 24b of the closure part 20 with the other hand, and moving the magnet-bearing part 10 and the closure part 20 relative to one other.

Attaching the Lid Assembly 100 to a Sample Tube 30

As shown in FIG. 8, the present lid assembly 100 can be attached to a sample tube 30, for example an Eppendorf Tube (RTM). Such a tube 30 has a body comprising a straight-sided region 31 and a tapered end region 32, with an opening 33 at the top, surrounded by a rim 35. As illustrated, the sample tube 30 may have an openable and closable cap 34, which is connected to the rim 35 of the tube by means of a flexible hinge 36. When in its closed position, the cap 34 seals the opening 33 of the tube. The cap 34 has a finger-tab 37 by which the user can urge the cap open, and an internal plug part 38 which locates within the rim 35 of the tube when the cap is closed.

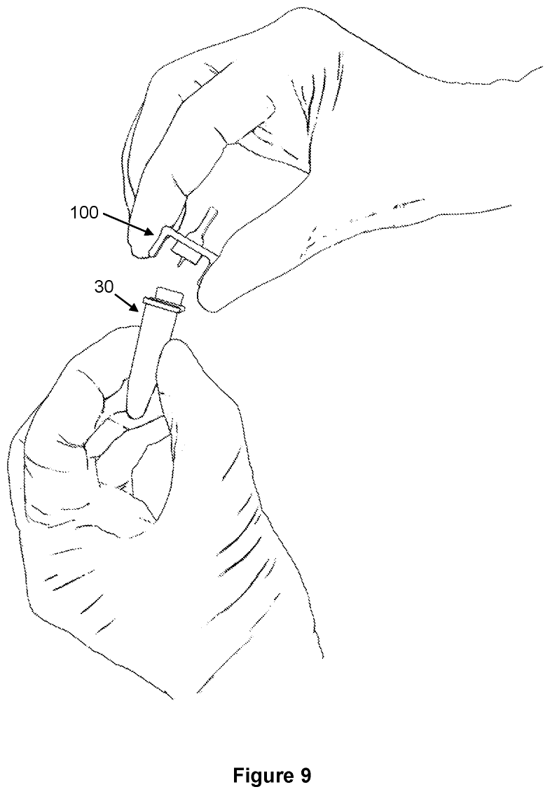

In use, to attach the present lid assembly 100 to the tube 30, the cap 34 (if present) of the tube 30 is first opened, and then the lid assembly 100 is brought into position in the direction of arrow D, engaging the bead-collecting platform 25 in the opening 33 of the tube 30 in a press-fit manner, with the rim 29 of the bead-collecting surface 26 forming a compression fit with the internal wall of the tube 30. As shown in FIG. 9, manipulation of the lid assembly 100 is performed by the user gripping the finger-tabs 24a, 24b of the closure part 20 with one other hand, and holding the tube 30 in the other hand, and bringing the two together. It should be noted that this press-fit manner of attachment is quick and easy to perform.

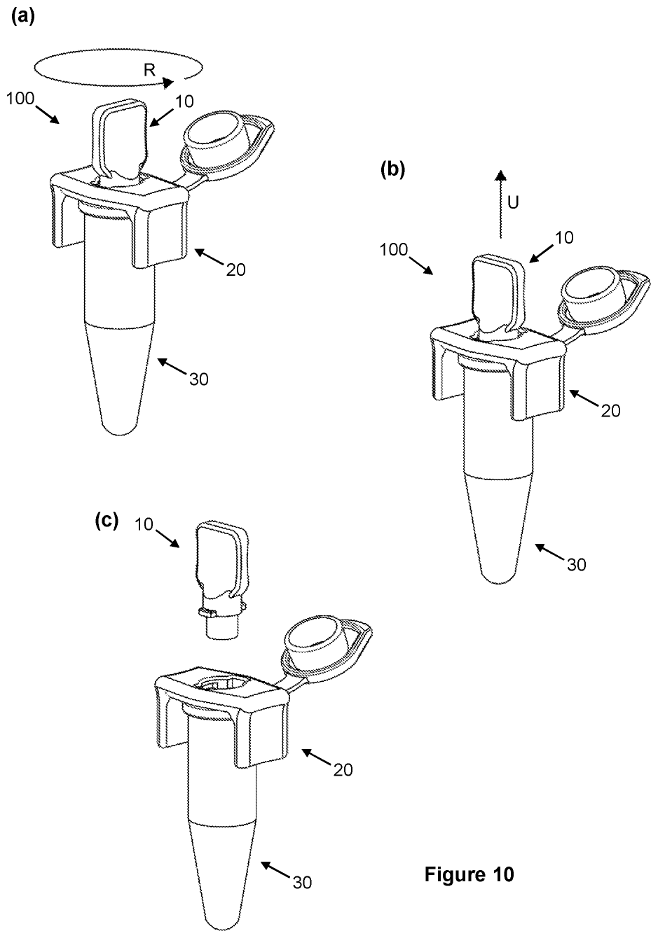

FIG. 10 illustrates the process of disengaging and separating the magnet-bearing part 10 of the lid assembly 100 from the respective closure part 20, with the closure part 20 remaining attached to the sample tube 30. Firstly (a) the magnet-bearing part 10 is rotated anticlockwise 90° relative to the closure part 20, as per arrow R, as described above in relation to FIG. 7. Then (b) the magnet-bearing part 10 is retracted upwards, in the direction of arrow U, out of the magnet-receiving cavity 22.

This results in (c) the magnet-bearing part 10 being separated from the closure part 20. As above, such manipulation of the magnet-bearing part 10 and the closure part 20 is performed by the user gripping the user-grippable part 13 of the magnet-bearing part 10 with one hand, and gripping the finger-tabs 24a, 24b of the closure part 20 with the other hand (with the closure part 20 in turn gripping the tube 30), and moving the magnet-bearing part 10 and the closure part 20 relative to one other.

Alternatively the user may simply grip the sample tube 30 (with the closure part 20 attached) with one hand, and rotate and retract the magnet-bearing part 10 with the other hand. The reverse procedure may be employed when introducing and engaging the magnet-bearing part 10 with the closure part 20 when in-situ on the sample tube 30.

FIG. 11 is a cross-sectional side view of (a) the disengagement process, and (b) the separation process, of FIG. 10. Also of note here is the cross-sectional geometry of the magnet 18, the bead-collecting platform 25, the bead-collecting surface 26, and the magnet-receiving cavity 22.

It can be seen that the magnet 18 and the magnet-receiving cavity 22 are dimensioned such that, when the magnet-bearing part 10 is engaged with the closure part 20, the magnet 18 contacts the bottom of the cavity 22 (or comes very close to it). Moreover, the thickness of the material between the bead-collecting surface 26 and the magnet-receiving cavity 22 is preferably made as thin as possible, whilst retaining a reliable level of strength and robustness, to enable the magnet 18 to come as close to the bead-collecting surface 26 as possible and thereby maximise the effect of the magnet's magnetic field on the magnetic beads 42 within the tube 30.

The cross-sectional profile of the bead-collecting surface 26 can also be seen, with its raised outer rim 29, recessed or concave region 28 in which to collect magnetic beads, and optional wicking member 27 in the centre.

In alternative variants of the closure part 20, the bead-collecting surface 26 may have a flat profile, or may be convex. A yet further possibility, irrespective of the overall profile of the bead-collecting surface 26, is for it to incorporate an array of depressions or recesses in which the magnetic beads 42 are held once attracted to the surface 26. This is with a view to achieving a uniform distribution of beads across the bead-collecting surface 26, so as to deter them from clumping—in turn enhancing their ability to dry, and also facilitating their subsequent release from the surface 26 upon removal of the magnet 18.

### Kits

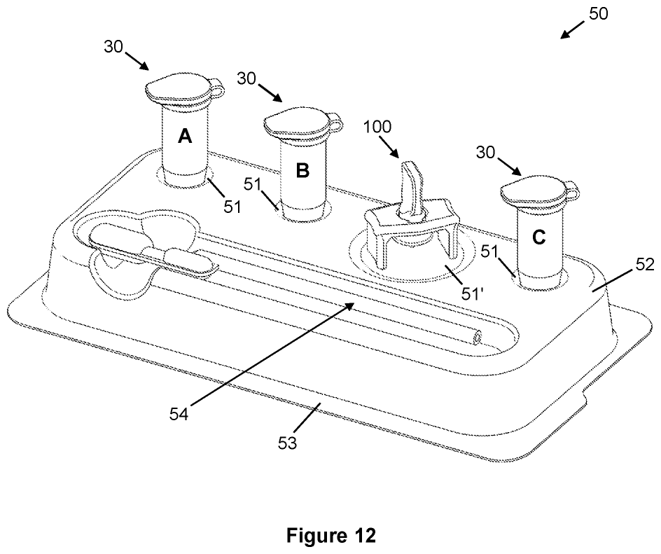

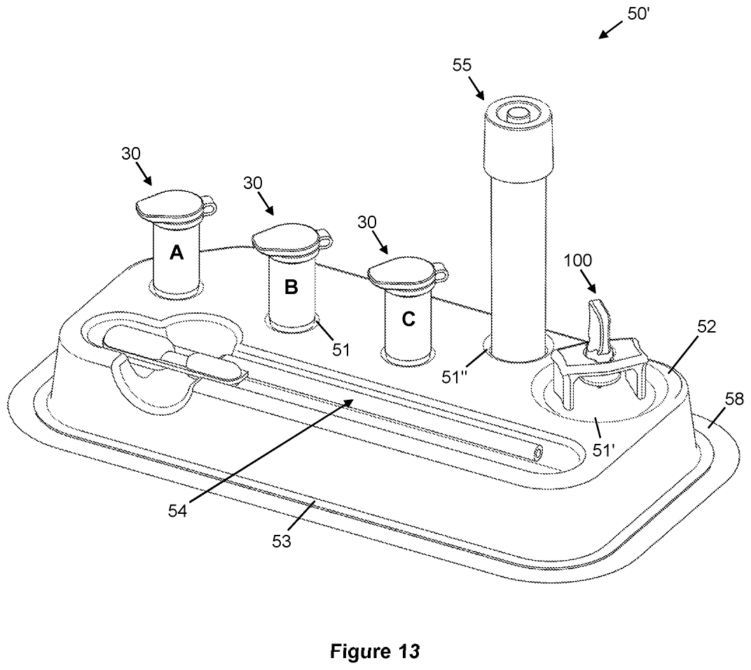

With reference to FIGS. 12 to 14, the present disclosure also provides kits comprising a lid assembly 100 as described above, one or more sample tubes 30, and optionally a pipette 54, and/or a swab, and/or a further sample collection tube 55 (in FIG. 13).

For example, FIG. 12 illustrates a kit 50 comprising a lid assembly 100, three sample tubes 30, and a pipette 54 (which in this case is an exact volume pipette). The kit 50 includes an inexpensive but useful packaging tray 52, made of moulded (e.g. thermoformed) plastic, which also functions as a stand for the sample tubes 30 and lid assembly 100. More particularly, the tray 52 incorporates a plurality of dedicated recesses or cavities 51 (integrally formed in the moulding of the tray) in which the sample tubes 30 are located, and also a dedicated recess 51′ on which the lid assembly 100 is placed, thus holding the sample tubes 30 and the lid assembly 100 in an upright orientation and removing the need for additional laboratory equipment such as a tube rack. Indeed, there is no need for even a bench or tabletop, as the present kit can in principle be used on any surface, including the user's lap when seated.

The tray 52 also has an outwardly-extending rim 53 that enhances the overall rigidity of the tray 52.

In this figure, and subsequently, the tubes 30 are labelled A, B and C, and reference to these labels will be made when describing methods of using such tubes together with the lid assembly 100, e.g. to perform extraction of targeted biomolecules from a sample using magnetic separation.

FIG. 13 is a perspective view of a variant 50′ of the kit of FIG. 12. As illustrated, the kit 50′ may further comprise (or be designed to receive) a further sample collection tube 55, which may also serve as a sample inactivation tube. A further dedicated recess or cavity 51″ may be formed in the tray 52 to hold tube 55 in an upright orientation. Tube 55 may be externally obtained, rather than being provided as part of the kit 50′. By inserting the tube 55 in the dedicated recess or cavity 51″, this enables the user to correlate a given sample spatially with the rest of the kit 50′, thus keeping all the tubes for a given sample together and reducing the possibility of any mix-up with tubes from another nearby kit.

It can also be seen that the kit 50′ is shown with a removable backing sheet 58 (which may be made of carboard or plastic) in place.

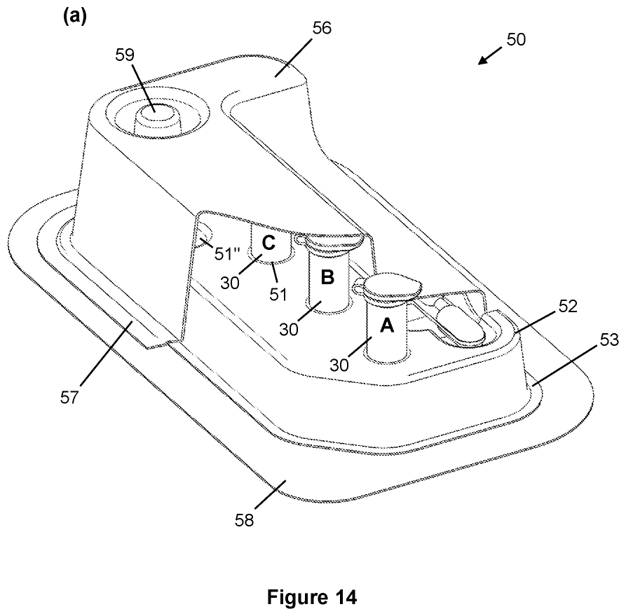

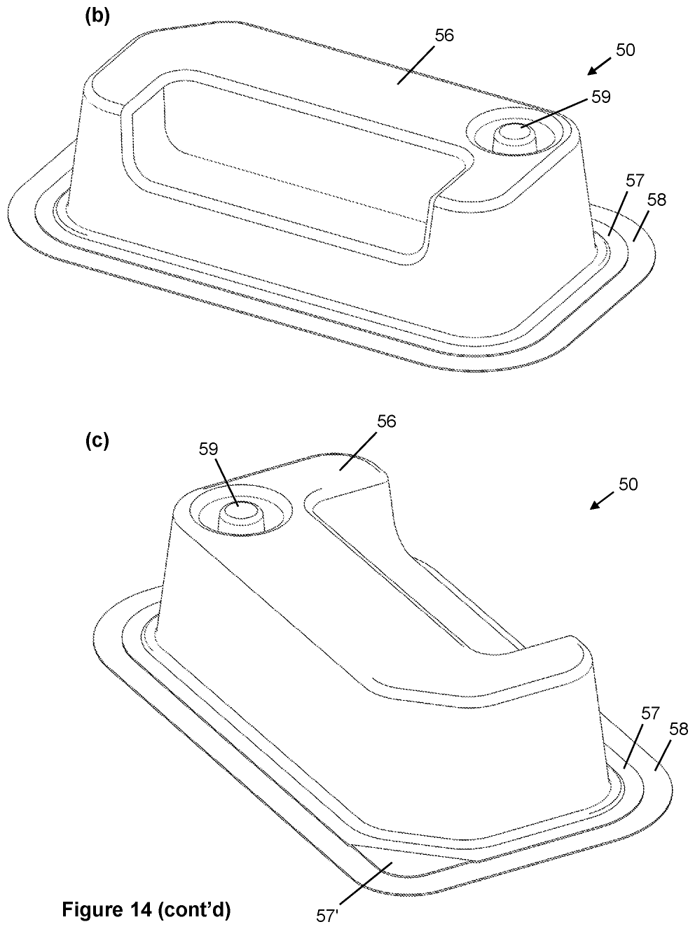

As shown in FIG. 14, such kits may also comprise a removable cover 56, again made of moulded (e.g. thermoformed) plastic, that extends over the tubes 30 and the lid assembly 100 and other contents. The cover 56 has a rim 57 which, during manufacture, is affixed to the backing sheet 58, and also holds the rim 53 of the tray 52 against the backing sheet 58 for transportation purposes, keeping the components therein sterile and in place. The cover 56 also incorporates a moulded feature 59 that conforms around the magnet-bearing part 10 of the lid assembly 100 when the kit is closed, and holds the lid assembly 100 in place during transportation. When removed in use, the cover 56 may serve as a waste receptacle for the sample tubes 30 and other contents of the kit, once they have been used, or as a temporary staging area. As illustrated, the cover 56 incorporates a peel corner 57′ that is part of the rim 57. The peel corner 57′ is raised relative to the rest of the rim 57, to allow easy opening of the cover 56 and detachment of the cover 56 from the backing sheet 58, thus opening the kit and releasing the tray 52 for use. As those skilled in the art will appreciate, other means of removably attaching the cover 56 to the tray 52 are possible, for example by means of snap-fit features between the cover 56 and the tray 52, that are integrally-formed as part of the thermoforming process of the cover 56 and tray 52.

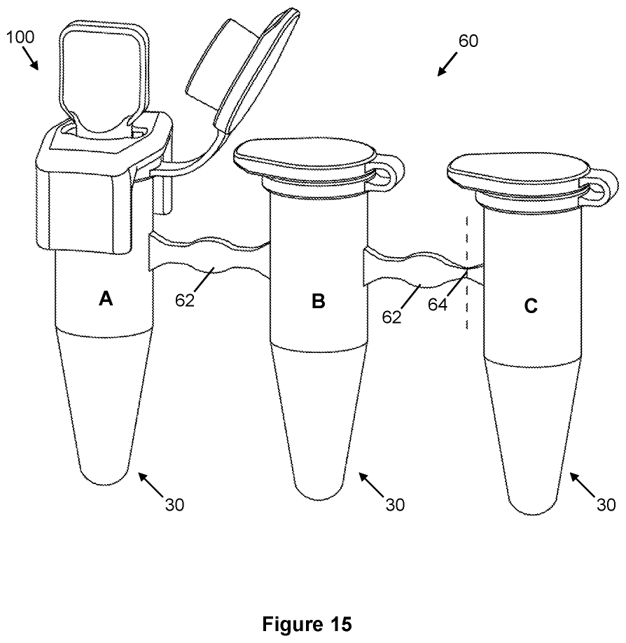

As shown in FIG. 15, another kit 60 provided by the present disclosure comprises a plurality of sample tubes 30 (in this case three) that are connected together, side by side, by means of connecting parts 62. Having the tubes 30 connected together in this manner may facilitate stepwise processing of the magnetic beads from tube to tube. The kit 60 also includes a lid assembly 100 that can be used with any of the tubes 30 (conveniently, by moving the lid assembly from tube to tube in sequence, i.e. from A to B and then to C). Optionally, the last of the sample tubes 30 (in this case, tube C) may be connected to its neighbouring tube (tube B) by a frangible connection 64, to enable the last tube (C) to be easily detached from the others and taken away separately for subsequent processing. It will of course also be appreciated that such a frangible connection 64 may be provided between any of the connected tubes 30, if so desired.

With all the above kits (50, 50′ and 60), the sample tubes 30 may be supplied already containing various liquids (of which examples will be described below). Moreover, the liquid in the first sample tube 30 may be preloaded with magnetic beads 42.

However, if there is any issue over the long-term stability of the magnetic beads 42 in the liquid of the first sample tube 30, then the magnetic beads 42 alone may be preloaded in the first sample tube 30, and the liquid may be provided in a separate container. For example, the liquid may be provided in a separate tube (for example, but not necessarily, a blow-fill-seal tube), or in a single-use tear-open sachet, capsule or blister pack from which the liquid may be transferred (e.g. squeezed) into the first sample tube 30 when required. Such a blister pack may be provided pre-attached to the opening of the first sample tube 30, such that the user is simply required to push on the blister pack to cause its underside (e.g. made of thin film or foil) to rupture and the liquid to be released into the first sample tube 30, to mix with the magnetic beads 42. The blister pack may then be removed from the opening of the first sample tube 30.

Alternatively, the liquid in question may be supplied in the first sample tube 30 and the magnetic beads 42 may be provided in a separate container, sachet, capsule, blister pack or blow-fill-seal tube, from which they may be transferred into the first sample tube 30 when required, in an analogous manner to the liquid as described above.

Method of Collecting Magnetic Beads from a Liquid within a Sample Tube

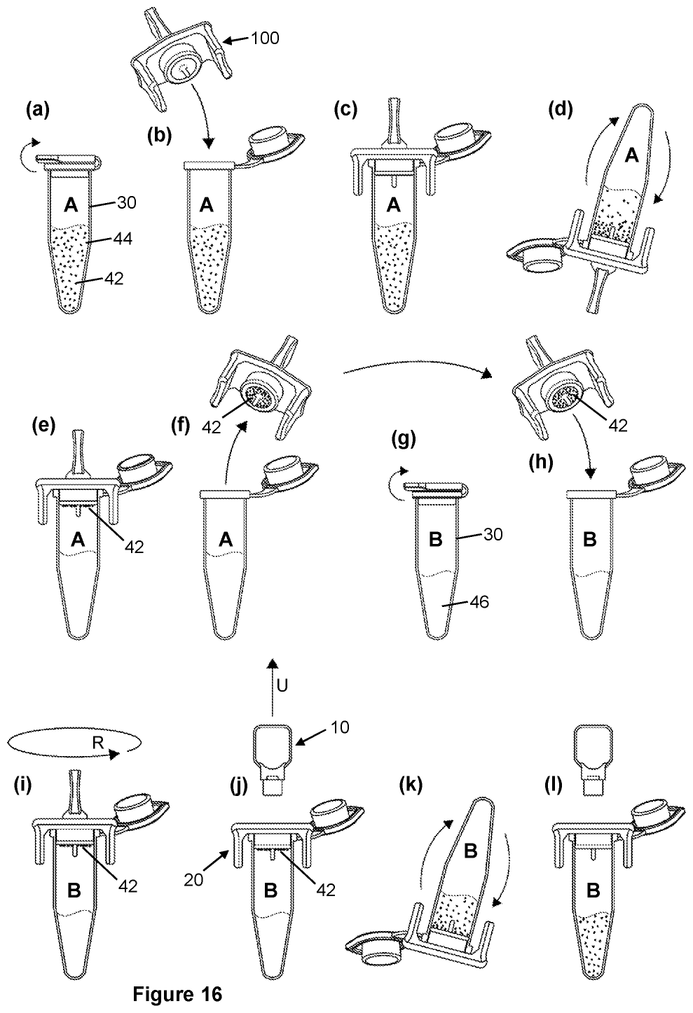

With reference to FIG. 16, and initially steps (a) to (f) thereof, the present disclosure provides a method of using the present lid assembly 100 to collect magnetic beads 42 from a liquid 44 within a sample tube 30, in which liquid 44 the beads 42 are suspended. For the sake of clarity, the reference numerals in FIG. 16 are not repeated from step to step, but it should be appreciated that the same items are used from step to step unless otherwise said. The features of the lid assembly will be referred to using the reference numerals as allotted in the preceding drawings.

The method will be explained in respect of collecting the magnetic beads 42 from the liquid 44 within sample tube A, starting from step (a) of FIG. 16.

As shown in step (a), the method first comprises the user opening the sample tube 30 (if indeed the tube is closed by a cap; the method is equally applicable for use with tubes that do not have caps and thus are already open, in which case step (a) would be omitted).

Then, as shown in step (b), the method comprises attaching the closure part 20 of the lid assembly 100 to the opening 33 of the sample tube 300, to result in the configuration shown in step (c). As described above, in the presently-preferred embodiments the method of attachment is by engaging the bead-collecting platform 25 in the opening 33 of the tube 30 in a press-fit manner, with the rim 29 of the bead-collecting surface 26 forming a compression fit with the internal wall of the tube 30. It should be noted that, at this stage, the magnet-bearing part 10—and more particularly the magnet 18—is inserted (and optionally locked, if a locking mechanism as described above is provided) in the magnet-receiving cavity 22 of the closure part 20.

Next, as shown in step (d), the method comprises gently agitating the liquid 44, e.g. by gently inverting the sample tube 30 or gently shaking the liquid 44, such that the magnetic beads 44 come into contact with the bead-collecting surface 26 and are held by the magnet 18 against the bead-collecting surface 26. The Illustration in step (d) shows a gradient of magnetic beads 42, concentrating towards the bead-collecting surface 26. In reality, the process of collecting the magnetic beads 42 on the bead-collecting surface 26 takes seconds.

Then, as shown in step (e), the magnetic beads 42 have been collected on the bead-collecting surface 26 of the lid assembly. Consequently the liquid in the tube is now clear (i.e. devoid of beads).

With reference now to step (f) onwards, the method may further comprises the user detaching the lid assembly 100 from sample tube A, with the magnet 18 still inserted in the magnet-receiving cavity 22 and the magnetic beads 42 held by the magnet 18 against the bead-collecting surface 26.

Sample tube A may be considered to be a first sample tube, and the liquid 44 contained therein may be considered to be a first liquid. At least a second sample tube 30 (here denoted as sample tube B) may be present, containing a second liquid 46 into which it is desired to release and resuspend the magnetic beads 42. Accordingly, the method may further comprise opening sample tube B (as shown in step (g), if sample tube B is indeed closed) and then, as shown in step (h), attaching the closure part 20 of the lid assembly 100 to the opening 33 of the second sample tube (tube B) containing the second liquid 46. At this stage, the magnetic beads 42 remain held against the bead-collecting surface 26 of the lid assembly 100.

Then, as shown in steps (i) and (j), to release the magnetic beads 42 from the bead-collecting surface 26, the method further comprises the user removing the magnet 18 from the magnet-receiving cavity 22, such that the magnetic beads 42 are no longer held by the magnet 18 against the bead-collecting surface 26. As outlined above with reference to FIGS. 10 and 11, the removal of the magnet 18 may require the user to first rotate the magnet-bearing part 10 (e.g. in anticlockwise direction R) as shown in step (i), and then retract the magnet-bearing part 10 upwards (in direction U), to separate it from the closure part 20. At this stage, due to the absence of the magnet 18, the magnetic beads 42 will no longer be magnetically held against the bead-collecting surface 26.

As shown in step (k), to resuspend the magnetic beads 42 in the second liquid 46 the user may gently agitate the liquid 46, e.g. by gently inverting sample tube B or gently shaking the liquid 46, such that the magnetic beads 42 come into contact with the liquid 46 and are swept off the bead-collecting surface 26 and become resuspended into the liquid. At this stage it is possible that at least some of the beads 42 will fall into the liquid 46 without such agitation of the liquid being required, although resuspension of the beads 42 in the liquid 46 happens more quickly and completely if such agitation is performed. This results in the configuration shown in step (l), wherein the magnetic beads 42 are now suspended in the second liquid 46, in tube B.

It will be appreciated that the above method may be continued to extract and transfer the magnetic beads 42 from tube B to a third sample tube (e.g. tube C illustrated in the above-described kits) containing a third liquid, and so on. Accordingly, following-on from the above step (l), the method may further comprise:
reinserting the magnet 18 in the magnet-receiving cavity 22;
agitating the second liquid 46 such that the magnetic beads 42 come into contact with the bead-collecting surface 26 and are held by the magnet 18 against the bead-collecting surface 26;
detaching the lid assembly 100 from the second sample tube (tube B), with the magnet inserted 18 in the magnet-receiving cavity 22 and the magnetic beads 42 held by the magnet against the bead-collecting surface 26;
attaching the closure part 20 of the lid assembly 100 to the opening of the third sample tube (tube C) containing the third liquid; and
removing the magnet 18 from the magnet-receiving cavity 22, such that the magnetic beads 42 are no longer held by the magnet 18 against the bead-collecting surface 26 and become suspended in the third liquid (following agitation of the third liquid against the bead-collecting surface 26 as required).

It will be appreciated that the above method is quick and easy to perform—particularly in view of the press-fit manner of attachment of the lid assembly 100 to the various sample tubes 30, and the corresponding ease with which the lid assembly 100 may be detached from the sample tubes; and also in view of the simple way in which the magnet-bearing part 10 may be detached from, or attached to, the closure part 20.

The ease of use of the present apparatus is further enhanced by the tray 52 which functions as a stand for the various components during use, thus facilitating entirely manual use of the present components without the need for any other tube rack or stand, and removing the need for the user to place anything on an external surface. This is particularly significant when the tubes are in an open state, in-between transfers of the magnetic beads, as placing open tubes on an external surface would increase the risk of contamination of the contents. The present apparatus, including the tray/stand 52, also advantageously facilitates single-handed use of the apparatus, which may at times be beneficial.

Method of Performing Extraction of Targeted Biomolecules from a Sample Using Magnetic Separation

To illustrate the advantages of the present lid assembly 100 and the above method in a practical context, a method of performing extraction of targeted biomolecules from a liquid (or solid) sample using magnetic separation will now be described, employing the present lid assembly 100 and magnetic beads 42 (which in this case are specifically magnetic nanoparticles). This method will be described with reference again to FIG. 16.

To initially summarise this method, targeted biomolecules such as DNA/RNA/proteins are first released from a sample through a lysis buffer, and are then bound to magnetic nanoparticles with a binding buffer. These beads are then washed using a washing liquid, to remove contaminants/chemicals from the previous step, as well as unwanted biological molecules. Once the beads have been washed, the purified analyte is eluted (released) from the beads through an elution buffer (e.g. molecular grade water, or Tris-EDTA (TE) buffer). The eluted analyte (e.g. RNA) may then be used for downstream molecular applications such as polymerase chain reaction (PCR) processing, isothermal amplifications, etc., according to the user's requirements. It will be appreciated that “Tris” is short for tris(hydroxymethyl)aminomethane, and EDTA is an abbreviation of ethylenediaminetetraacetic acid.

Thus, to perform this method, first, second and third sample tubes (e.g. tubes A, B and C of the above-described kits) are used, respectively containing first, second and third liquids. In a general sense, the first liquid is a lysis/binding buffer liquid, for lysing the targeted biomolecules and thereby releasing them into solution, and binding the biomolecules to the magnetic beads; the second liquid is a washing liquid; and the third liquid is an elution liquid, for eluting the biomolecules.

In more detail, with reference to FIG. 16, the method comprises the following steps:

### Preliminary Step 1:

A biological sample (for example, a nasal secretion that is suspected to contain viral particles, such as SARS-CoV-2 particles) is collected using a nasopharyngeal swab and placed into a sample collection tube 55 (e.g. a so-called eNAT (RTM) tube) containing an inactivation buffer.

### Preliminary Step 2:

Using a pipette 54 (which may advantageously be an exact volume disposable pipette), a quantity of the inactivation buffer containing the eluted viral particles from the swab is transferred from the sample collection tube 55 into a first sample tube 30, namely tube A in FIG. 16, and the mixture is gently shaken. Tube A has been preloaded with lysis/binding buffer liquid (e.g. based on guanidinium thiocyanate, and optionally including a solvent such as isopropanol or ethanol) and magnetic beads 42, and now also contains the eluted viral particles from the swab. The magnetic beads 42 have a silica coating which binds nucleic acids from the viral particles.

With reference now to FIG. 16:
Step (a): The lid of tube A is opened.
Step (b): The lid assembly 100 (with the magnet-bearing part 10 engaged with the closure part 20) is brought up to tube A.
Step (c): The lid assembly 100 is attached to tube A.
Step (d): Tube A, with lid assembly 100 attached, is gently inverted to collect the magnetic beads 42 on the bead-collecting surface 26, via magnetic attraction.
Step (e): The magnetic beads 42 have been collected on the bead-collecting surface 26 of the lid assembly 100. Consequently the liquid in the tube is now clear (devoid of beads).
Step (f): The lid assembly 100, holding the magnetic beads 42, is detached from tube A.
Step (g): A second sample tube 30, namely tube B in FIG. 16, is opened. Tube B contains a washing liquid (e.g. a solution of 80% ethanol, for example).
Step (h): The lid assembly 100, holding the magnetic beads 42, is attached to tube B.
Steps (i) and (j): The magnet-bearing part 10 is disengaged and removed from the closure part 20, such that the magnetic beads 42 are no longer magnetically held against the bead-collecting surface 26.
Step (k): The magnetic beads 42 come away from the bead-collecting surface 26 and are resuspended in the washing liquid by gently inverting or shaking tube B, thereby washing the beads and removing contaminants/chemicals from the previous steps, as well as unwanted biological molecules. This results in the configuration shown in step (l).

Following-on from step (l), the method further comprises the following steps: Step (m): The magnet-bearing part 10 is reinserted in the magnet-receiving cavity 22 of the closure part 20 (which is still attached to tube B).
Step (n): Tube B, with lid assembly 100 attached, is gently inverted to collect the magnetic beads 42 on the bead-collecting surface 26, via magnetic attraction.
Step (o): The lid assembly 100, holding the magnetic beads 42, is detached from tube B.
Step (p): The magnetic beads 42 on the detached lid assembly 100 are exposed to the air for 30 seconds to allow the washing liquid (in this case, ethanol solution) to evaporate. If a kit 50 such as that shown in FIG. 12 is used, the lid assembly 100 may advantageously be placed in the dedicated recess 51′ at this stage, to allow the magnetic beads 42 to dry whilst keeping the lid assembly 100 and the beads 42 away from external sources of potential contamination.
Step (q): The lid assembly 100, holding the magnetic beads 42, is attached to the opening of the third sample tube (tube C) containing the elution liquid.
Step (r): The magnet-bearing part 10 is disengaged and removed from the closure part 20, such that the magnetic beads 42 are no longer magnetically held against the bead-collecting surface 26.
Step (s): The magnetic beads 42 come away from the bead-collecting surface 26 and are resuspended in the elution liquid by gently inverting tube C, to cause elution of the analyte in question (e.g. characteristic RNA of the abovementioned viral particles), for subsequent processing.

Optionally, to remove the magnetic beads 42 from the elution liquid, the method may further comprise the following additional steps:
Step (t): The magnet-bearing part 10 is reinserted in the magnet-receiving cavity 22 of the closure part 20 (which is still attached to tube C) and the magnetic beads 42 are extracted from the elution liquid by gently inverting tube C, thereby recollecting the magnetic beads 42 on the bead-collecting surface 26 via magnetic attraction. Consequently, only the eluted analyte (e.g. characteristic RNA of the abovementioned viral particles) is left in the elution liquid, for subsequent processing.
Step (u): The lid assembly 100 may now be detached from tube C and disposed of, together with the used magnetic beads 42. The magnet-bearing part 10 may be kept and re-used if desired.

The whole process, from sample (e.g. nasopharyngeal swab, saliva or blood) to extracted RNA can be performed in under five minutes by substantially untrained users at point-of-care.

Experimental Validation of the Above Method

The above-described technique was performed experimentally and comparative tests were performed using a “gold standard” column-based extraction method from Qiagen: QIAamp Viral RNA Mini Kit. A total of six samples containing cultured SARS-CoV-2 (10⁷ PFU/mL) were analysed by both methods and extracted RNA was quantified by RT-qPCR targeting the E gene. Recovery results showed equivalent performance with an average of 3×10¹⁰ and 1.4×10¹⁰ total RNA copies for the Qiagen kit and the present technique respectively. These promising results indicate that the present frugal, quick and easy extraction method can compete very favourably with conventional laboratory-based extraction techniques which require expensive equipment and electricity, and which incur delays of over 30 minutes.

Advantages of the Above Methods and Apparatus

Conventionally, sample preparation plays a critical role in the analytical sciences. The present method overcomes the limits related to pre-existing expensive, time-consuming and complex molecular extraction kits by providing a new approach that allows a quick (under five minutes) extraction process of different molecules from different sources of clinical samples (e.g. different kinds of swabs and biological samples). The presently-disclosed method and apparatus requires minimal steps/time and reagents, no centrifugation or vortexing, no electricity, no use of expensive equipment, and no detailed prior training, and provides a cost-effective, robust and safe kit, suitable for single use, that is easily implementable in low-resource or remote settings.

The above advantages, and others, are obtained by virtue of the following:
The utilisation of the above-described controllably-magnetisable lid assembly 100 for single-use (e.g. Eppendorf (RTM)) sample tubes to collect magnetic beads 42, and to transfer target particles attached to the magnetic beads through one or more subsequent sample preparation steps (e.g. lysis/binding, to washing, to elution).
The lid assembly being adaptable for any tube type (e.g. screw top, snap top, etc.) or size (e.g. 0.5 ml, 1 ml, 1.5 ml, etc.).
The magnet 18 being removable from the closure part 20 to allow for easy resuspension of beads at each step if desired.
The ability to move the magnetic beads 42 through multiple prefilled tubes, rather than adding/removing chemicals or solutions to/from a single tube containing the beads.
The design of the lid assembly to protect the magnetic beads 42 from accidental surface contact or user contact (e.g. as shown in FIGS. 5 and 6).
The optional provision of a wicking member (e.g. wicking spike) on the bead-collecting surface 26, to prevent liquid retention through surface tension.

Compared to pre-existing techniques, the use of the present lid assembly achieves or enables the following:
Removes the need for electrical equipment (centrifuge, vortex mixers, mains-powered heaters, safe cabinet, etc.).
Removes the need for expensive micropipettes to transfer liquids.
Does not require the use of a silica-based membrane to purify the product.
Brings the minimal extraction time of at least 30 minutes required from commercially-available kits down to under five minutes.
Removes the need for laboratory-based environment and a mains electrical supply, and is thus usable as a point-of-care extraction method in remote locations.
With the presently-described kits (in which the packaging/tray serves as a stand) there is no need for any other tube rack or stand, and no need for the user to place anything on an external surface, thus reducing the risk of contamination of the test apparatus and liquids. Indeed, there is no need for even a bench or tabletop, as the present kit can in principle be used on any surface, including the user's lap when seated.
Room temperature storage is suitable for the kit (no freezer required).
Removes the need for highly-skilled personnel to perform the extraction.
Extremely frugal—typically less than 1 GBP per sample.

### Modifications, Alternatives and Accessories

Detailed embodiments and some possible alternatives have been described above. As those skilled in the art will appreciate, a number of modifications and further alternatives can be made to the above embodiments whilst still benefiting from the inventions embodied therein.

In the above-described embodiments of the lid assembly 100, the magnet-bearing part 10 is entirely separable from the closure part 20, and insertable into the magnet-receiving cavity 22 of the closure part 20, so as to position the magnet 18 close behind the bead-collecting surface 26 in order to attract magnetic beads 42 towards and onto the bead-collecting surface 26.

However, alternative configurations of the lid assembly may be envisaged, still based around the principles of bringing a magnet towards a rear side of a bead-collecting surface, in order to attract magnetic beads towards and onto the front (liquid-facing) side of the bead-collecting surface when so desired, and moving the magnet away from the rear side of the bead-collecting surface when attraction of the beads to the surface is not required (i.e. when the magnetic beads are to be released).

For instance, the magnet need not be part of an entirely separable magnet-bearing part. Instead, the magnet or magnet-bearing part could remain coupled to the closure part, whilst being controllably moveable towards or away from the rear side of the bead-collecting surface. In one such example, the magnet-bearing part may be tethered to the closure part. In another example, the removability of the magnet-bearing part from the closure part may be limited by a restraining mechanism, whilst still permitting the magnet-bearing part to be moved towards or away from the rear side of the bead-collecting surface. Such movement may be (but need not be) linear. For instance, in another variant the magnet could be moveable towards or away from the rear side of the bead-collecting surface by means of a rocker switch mechanism. Another arrangement for controllably advancing or retracting the magnet relative to the rear side of the bead-collecting surface could employ a push button mechanism broadly similar to that of a retractable ballpoint pen.

In the above-described embodiments of the lid assembly 100, the engagement process of the magnet-bearing part 10 with the closure part 20 involves linear insertion of the magnet-bearing part 10 into the cavity 22 of the closure part 20, followed by rotation of the magnet-bearing part 10 relative to the closure part 20 (e.g. through 90°), to engage the first and second radial protrusions 16a, 16b along the respective circumferential channels 23.

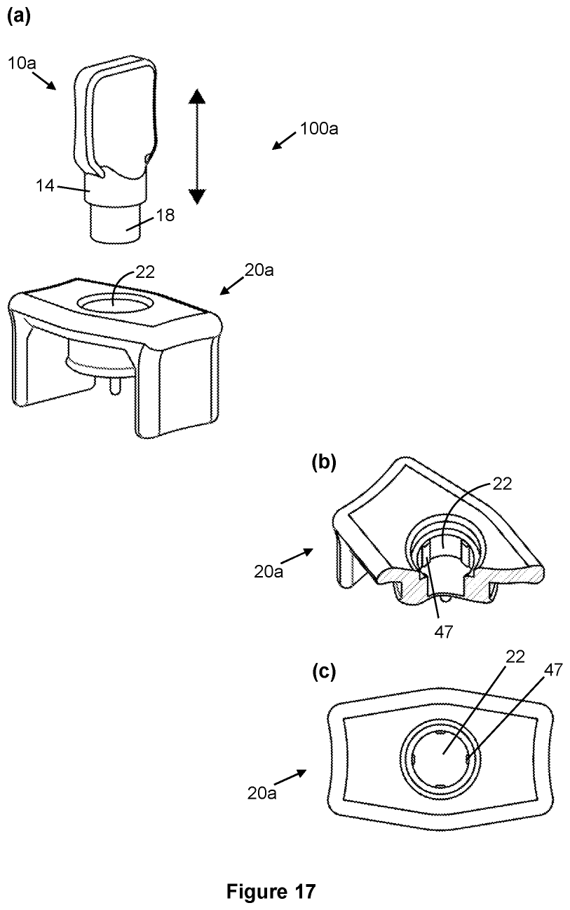

However, as shown in FIG. 17, a variant of the lid assembly 100a may omit the rotational engagement principle and the associated features, and only employ linear insertion to engage the magnet-bearing part 10a with the closure part 20a (as denoted by the double-headed arrow in FIG. 17(a)). Accordingly, the shaft 14 of the magnet-bearing part 10a is smooth and lacks the radial protrusions 16a, 16b of FIG. 1. Similarly, as shown in FIGS. 17(b) and 17(c), the magnet-receiving cavity 22 of the closure part 20a lacks the circumferential channels 23 of FIG. 1. To provide a degree of engagement, however, the closure part 20a may incorporate gripping means (in this case, longitudinal protrusions/ridges 47) within the magnet-receiving cavity 22, for gripping the magnet-bearing part 10a. In all other material respects, the features of the lid assembly 100a are the same as those of the above-described lid assembly 100 (e.g. as shown in FIG. 1).

For apparatus in which rotational engagement of the magnet-bearing part 10 with the closure part 20 is not required, the shaft 14 of the magnet-bearing part 10 need not be cylindrical, and may instead have a cross-sectional shape that does not permit rotation (e.g. a square shape).

In passing, it should also be noted that, even with the above-described lid assembly 100 that provides for linear insertion and then rotational engagement of the magnet-bearing part 10 with the closure part 20, if the user wishes they can omit the rotational step once the magnet 18 has been inserted into the cavity 22, e.g. in order to further expedite the process. However, under such circumstances the user should take care to ensure that the magnet-bearing part 10 does not accidentally come away from the closure part 20 at an inopportune moment, e.g. by applying gentle pressure on top of the magnet-bearing part 10 to hold it in place.

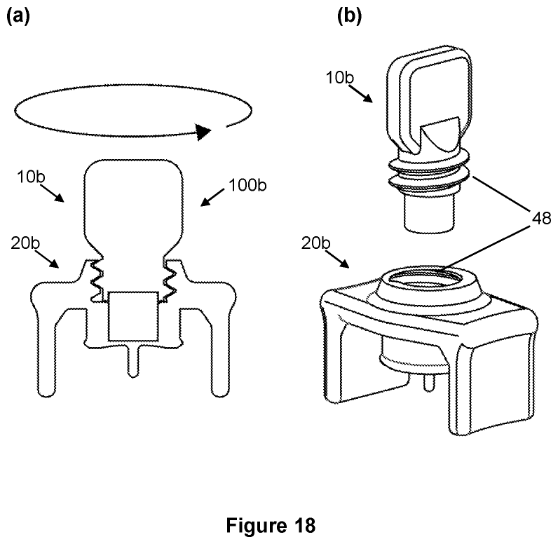

FIG. 18 illustrates (a) a cross-sectional engaged view, and (b) a perspective disengaged view, of another variant 100b of the lid assembly of FIG. 1, wherein the magnet-bearing part 10b and the closure part 20b comprise mutually-engageable threads 48 (which may optionally be multi-start threads). In all other material respects, the features of the lid assembly 100b are the same as those of the above-described lid assembly 100 (e.g. as shown in FIG. 1).

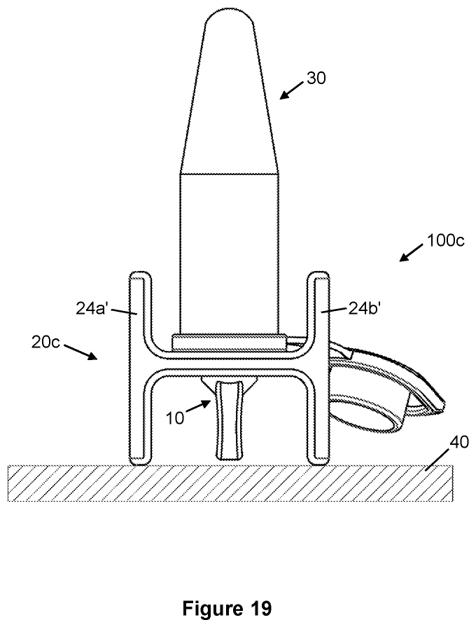

In respect of the above-described embodiments of the lid assembly 100, it was explained that the first and second finger-tabs 24a, 24b extend below the bead-collecting surface 26 and can therefore be used as a stand to support the lid assembly 100 in an upright orientation on a surface 40 (as shown in FIG. 6). Under some circumstances, however, it may be advantageous to be able to support the lid assembly upside-down, with the sample tube 30 attached—e.g. to enable gravity to assist in the collection of the magnetic beads 42 on the bead-collecting surface 26. To this end, FIG. 19 illustrates another variant 100c of the lid assembly of FIG. 1, wherein the first and second finger-tabs 24a′, 24b′ of the closure part 20c extend both below and above the bead-collecting surface 26, to a sufficient extent to enable them to act as a stand for supporting the lid assembly 100c upside-down with a sample tube 30 attached (as well as, alternatively, upright without a sample tube attached). In all other material respects, the features of the lid assembly 100c are the same as those of the above-described lid assembly 100 (e.g. as shown in FIG. 1).

In yet another variant (not illustrated), the first and second finger-tabs of the closure part may extend only above the bead-collecting surface (i.e. the opposite of FIG. 6), to as sufficient extent to enable them to act as a stand that can only support the lid assembly upside-down (optionally with a sample tube attached).

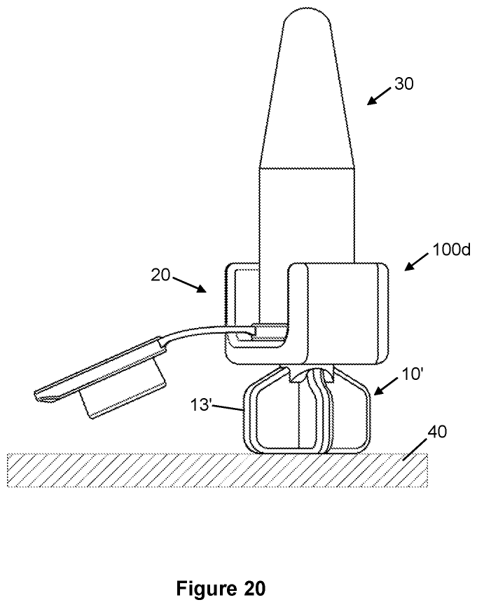

FIG. 20 illustrates another variant 100d of the lid assembly of FIG. 1, wherein the user-grippable part 13′ of the magnet-bearing part 10′ has a wide cross-sectional profile (in this case, cross-shaped) such as to enable it to act as a stand for supporting the magnet-bearing part 10′ upside-down. This is instead of the user-grippable part 13 having a relatively thin and planar shape, as in FIG. 1, which is unsuited for stably supporting the magnet-bearing part 10 upside-down, unaided.

Preferably, as shown in FIG. 20, the cross-sectional profile of the illustrated variant of the user-grippable part 13′ provides a sufficiently stable stand such that it can also support the attached closure part 20 and an attached sample tube 30 upside-down, if so desired.

### Modified Sample Tube, and Method of Use

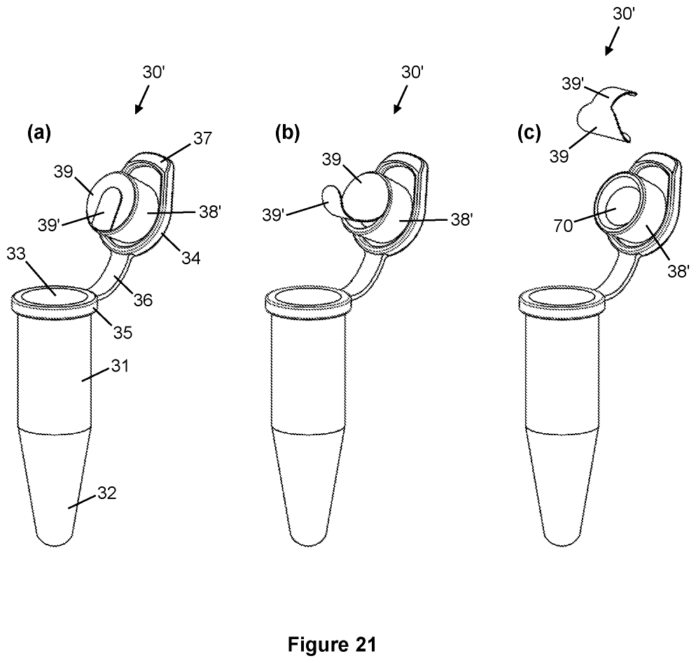

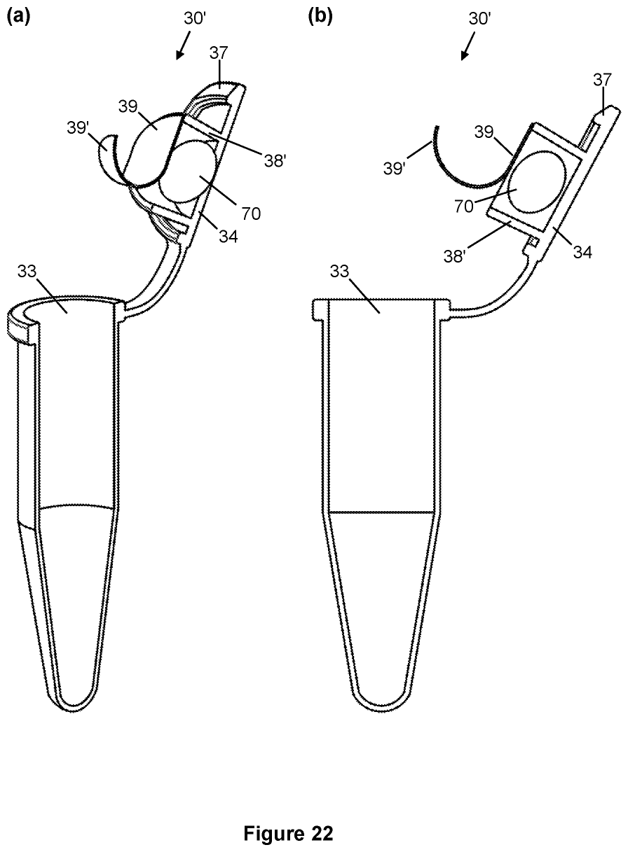

As illustrated in FIGS. 21 and 22, the present disclosure also provides a modified sample tube 30′, that is a variant of the sample tube 30 referred to above.

Similar to conventional sample tubes as described above, the modified sample tube 30′ has a body comprising a straight-sided region 31 and a tapered end region 32, with an opening 33 at the top, surrounded by a rim 35. (It will be appreciated that other geometries of the modified sample tube 30′ are also possible, i.e. that it does not necessarily need to have a straight-sided region 31 or a tapered end region 32 as illustrated.) The sample tube 30′ further comprises an openable and closable cap 34, which is connected to the rim 35 of the tube by means of a flexible hinge 36. The cap 34 has a tab 37 by which the user can urge the cap open.

However, in contrast to conventional sample tubes, the cap 34 of the modified sample tube 30′ further comprises a compartment 38′ containing a quantity of a reagent (which, as illustrated, may be in the form of a bead 70 or tablet). The compartment 38′ has a removable cover 39, e.g. made of foil or plastic film, that seals the contents of the compartment 38′. The cover 39 may be provided with an integral pullable tab 39′, that is initially folded onto the rest of the cover 39, to enable quick and easy removal of the cover 39 as and when required. It will be appreciated that the compartment 38′ is on the inside of the cap 34 and locates within the rim 35 of the tube 30′ when the cap is closed.

The reagent (e.g. bead 70) is inserted into the compartment 38′, and the cover 39 attached, in a manufacturing facility. During manufacture, the compartment 38′ may preferably be sealed by the cover 39 in a low oxygen environment, to maximise the longevity of the reagent.

As illustrated, the reagent may advantageously be in the form of a bead 70 or tablet, thereby facilitating loading of the reagent into the compartment 38′, allowing for long-term room temperature storage, and enabling the entirety of the reagent, as one, to exit the compartment 38′ and pass into the body of the tube. Alternatively, however, the reagent may be in the form of dry powder, or even a liquid or gel.

The reagent may be loose within the compartment 38′, such that, in use, when the cover 39 is removed from the compartment 38′ and the cap 34 is closed onto the opening 33 of the tube 30′, the reagent simply falls into the body of the tube, and into any liquid therein. Such falling of the reagent may be facilitated if the reagent is in the form of a bead 70 or tablet, as outlined above.

Alternatively, the reagent, if in the form of a bead 70 or tablet (or cake) may be mounted within the compartment 38′ in a secure manner, e.g. by press-fitting it into a moulded recess within the compartment 38′, thereby preventing the reagent bead 70 from inadvertently falling out of the compartment (e.g. onto the floor) when the cover 39 has been removed and the cap 34 is being moved into its closed position. With such a press-fitted quantity of reagent, the user may be required to flush/dissolve the reagent bead 70 out of the compartment 38′ using liquid within the tube, by inverting the tube 30′ once the cover 39 has been removed from the compartment 38′ and the cap 34 has been closed onto the body of the tube 30.

The reagent (e.g. bead 70) may be any chemical substance. That said, following-on from the above-described method of performing extraction of targeted biomolecules (such as the characteristic RNA of a particular virus) from a sample using magnetic separation, the reagent may usefully be a lyophilized colorimetric detection reagent, that may be introduced into the elution liquid that contains (or potentially contains) the eluted targeted biomolecules, to determine the presence or absence of the targeted biomolecules via colorimetric analysis.

Accordingly, in the above-described method, tube C (containing the elution liquid) may be a modified sample tube 30′, with the reagent bead 70 being a lyophilized colorimetric detection reagent, preferably in bead or tablet form. Such a tube C, prefilled with the elution liquid and preprepared with the lyophilized colorimetric detection reagent bead 70 within the sealed compartment 38′ on the inside of the cap 34 of the tube, may form part of one of the above-described kits (e.g. as shown in FIGS. 12 to 15).

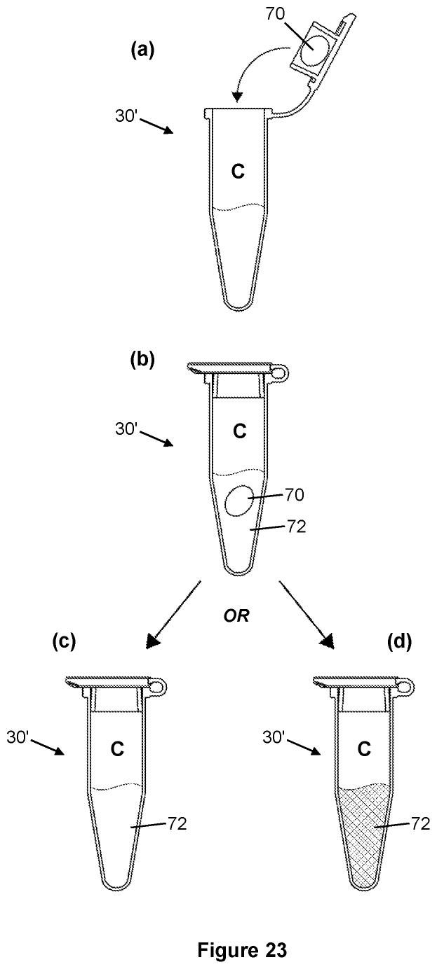

FIG. 23 illustrates this colorimetric analysis process. As step (a) the reagent bead 70 is released from the cap compartment 38′ of the sample tube 30′, such that, as step (b), the reagent bead 70 enters the elution liquid 72 in the body of the sample tube. At this stage, the reagent bead 70 will quickly dissolve and mix with the elution liquid 72. It will be appreciated that all the chemical species required to carry out nucleic acid amplification (e.g. PCR or LAMP) of the targeted biomolecules (e.g. virus RNA) are now present—and, by virtue of the present work, can be provided in kit form, suitable for use in a remote field location by a substantially untrained user.

To cause the colorimetric amplification process to take place, it may be necessary to heat the contents of the sample tube 30′, for example to ˜63° C., and hold the contents at such a temperature for a period of time, such as ˜20 minutes. This causes the targeted nucleic acid, if present, to be amplified, and thereby causes the colour of the liquid to change. This is illustrated as step (d) of FIG. 23.

On the other hand, if the targeted nucleic acid is not present, no amplification will take place, and consequently the colour of the liquid will not change, as illustrated as step (c) of FIG. 23.

When carried out in a remote field location away from an electricity supply, the above heating may be provided by a chemical heat pack (e.g. which is “snapped” to activate, causing an exothermic reaction to take place, that releases heat), or by means of a small battery-powered or solar-powered heater block into which the sample tube 30′ may be inserted.

It will therefore be appreciated that all aspects of the present disclosure are suitable for use in remote field locations.

### Reagents

More generally, the above-described reagent (e.g. bead 70) may comprise various chemicals or other species (e.g. enzymes, primers, etc.), and mixtures thereof, necessary for a variety of nucleic acid amplification methods.

For example, the nucleic acid amplification method may comprise polymerase chain reaction (PCR), reverse transcription PCR (RT-PCR), quantitative PCR (qPCR), reverse transcription qPCR (RT-qPCR), nested PCR, multiplex PCR, asymmetric PCR, touchdown PCR, random primer PCR, hemi-nested PCR, polymerase cycling assembly (PCA), colony PCR, ligase chain reaction (LCR), digital PCR, methylation specific-PCR (MSP), co-amplification at lower denaturation temperature-PCR (COLD-PCR), allele-specific PCR, intersequence-specific PCR (ISS-PCR), whole genome amplification (WGA), inverse PCR, or thermal asymmetric interlaced PCR (TAIL-PCR).

In some embodiments, the nucleic acid amplification reaction may be a nucleic acid isothermal amplification method. Isothermal amplification is a form of nucleic acid amplification which does not rely on the thermal denaturation of the target nucleic acid during the amplification reaction and hence does not require multiple rapid changes in temperature. Isothermal nucleic acid amplification methods can therefore be carried out inside or outside of a laboratory environment. A number of isothermal nucleic acid amplification methods have been developed, including but not limited to Strand Displacement Amplification (SDA), Transcription Mediated Amplification (TMA), Nucleic Acid Sequence Based Amplification (NASBA), Recombinase Polymerase Amplification (RPA), Rolling Circle Amplification (RCA), Ramification Amplification (RAM), Helicase-Dependent Isothermal DNA Amplification (HDA), Circular Helicase-Dependent Amplification (cHDA), Loop-Mediated Isothermal Amplification (LAMP), Single Primer Isothermal Amplification (SPIA), Signal Mediated Amplification of RNA Technology (SMART), Self-Sustained Sequence Replication (3SR), Genome Exponential Amplification Reaction (GEAR) and Isothermal Multiple Displacement Amplification (IMDA). Further examples of such amplification chemistries are described in, for example, “Isothermal nucleic acid amplification technologies for point-of-care diagnostics: a critical review” (Pascal Craw and Wamadeva Balachandrana Lab Chip, 2012, 12, 2469-2486, DOI: 10.1039/C2LC40100B).

In certain presently-preferred embodiments, the reagent (e.g. bead 70) may contain ingredients for making any of the aforementioned amplification chemistries compatible with pH-based or colorimetric detection (e.g. pH-LAMP). This may be accomplished, for example, by reducing buffer capacity (possibly through the absence of tris-HCL).

The reagent (e.g. bead 70) may encompass a wide range of chemistries for visual (or other) detection of a targeted species, providing an amplification indicator.

For example, in certain embodiments, an amplification indicator substance may be an organic or inorganic compound that is added to a nucleic acid amplification reaction mix so that the content of the solution (such us, for example, the presence or absence of specific nucleic acids) can be determined visually.

In certain embodiments, the amplification indicator substance may be a metal ion indicator (also called a complexometric indicator or metallochromic indicator), which is a substance that changes colour after forming a metal ion complex with a colour different from that of the uncomplexed indicator (such as, for example, but not limited to, Ca²⁺, Mg²⁺, Zn²⁺, and other metal ions).

Other amplification indicator substances are possible, that will be familiar to those skilled in the art, such as, for example, but not limited to, hydroxynaphthol blue, eriochrome black t, calmagite, curcumin, fast sulphon black, hematoxylin, murexide, xylenon orange, BAPTA, BAPTA AM, BTC, BTC AM, Calcein, Calcein AM, Calcein Blue, Calcium Green 1, Calcium Green 2, Calcium Green 5N, Coelenterazine, Coelenterazine cp, Coelenterazine f, Coelenterazine h, Coelenterazine hcp, Coelenterazine n, CoroNa Green, Corona Green AM, CoroNa Red, DAF FM, Fluo 3, Fluo 3 AM, PBFI AM, Phen Green SK, Quin 2, Quin 2 AM, and RhodZin 3.

In other embodiments, the amplification indicator substance may be a pH indicator. As those skilled in the art will appreciate, a pH indicator is a chemical detector for hydronium ions (H₃O⁺) or hydrogen ions (H⁺). Normally, the indicator causes the colour of the solution to change depending on the pH. Indicators can also show change in other physical properties. For example, olfactory indicators show change in their odour.

Other possible amplification indicator substances include for example, but are not limited to: gentian violet, malachite green, thymol blue, methyl yellow, bromophenol blue, congo red, methyl orange, screened methyl orange (first transition), screened methyl orange (second transition), Bromocresol green, methyl red, methyl purple, azolitmin red, bromocresol purple, bromothymol blue, phenol red, neutral red, naphtholphthalein, Cresol red, Cresolphthalein, Phenolphthalein, Thymolphthalein, Alizarine Yellow R yellow, and Indigo carmine.

In other embodiments, the amplification indicator substance can be a redox indicator (also called an oxidation-reduction indicator), which is an indicator dye that undergoes a definite colour change at a specific electrode potential. There are two common types of redox indicators: pH independent redox indicators and pH dependent redox indicators.

pH independent redox indicators include, but are not limited to, 2,2′-bipyridine, Nitrophenanthroline, N-Phenylanthranilic acid, 1,10-Phenanthroline iron(II) sulfate complex, N-Ethoxychrysoidine, 2,2′-Bipyridine, 5,6-Dimethylphenanthroline, o-Dianisidine, Sodium diphenylamine sulfonate, Diphenylbenzidine, Diphenylamine, and Viologen.

pH dependent redox indicators include, but are not limited to, Sodium 2,6-Dibromophenol-indophenol, Sodium o-Cresol indophenol, Thionine, Methylene blue, Indigotetrasulfonic acid, Indigotrisulfonic acid, Indigo carmine, Indigomono sulfonic acid, Phenosafranin, Safranin, and Neutral red.

Whilst, in the above discussion, the reagent is described as being in the form of a bead 70, mounted in the cap compartment 38′ of the modified sample tube 30′, it will be appreciated that a quantity of reagent (e.g. in the form of a bead 70) can be provided in other ways, for introduction into the elution liquid at the appropriate time. For example, a reagent bead 70 (or quantity of reagent in another form) may be provided in a separate tube (for example, but not necessarily, a blow-fill-seal tube), container or tear-packet/sachet, which may be opened at the appropriate time to enable the reagent to be transferred into the sample tube containing the elution liquid. Such a tube, container or tear-packet/sachet containing the reagent may be provided as part of one of the kits described herein.

### Handheld Device for Manually Agitating or Inverting a Plurality of Sample Tubes

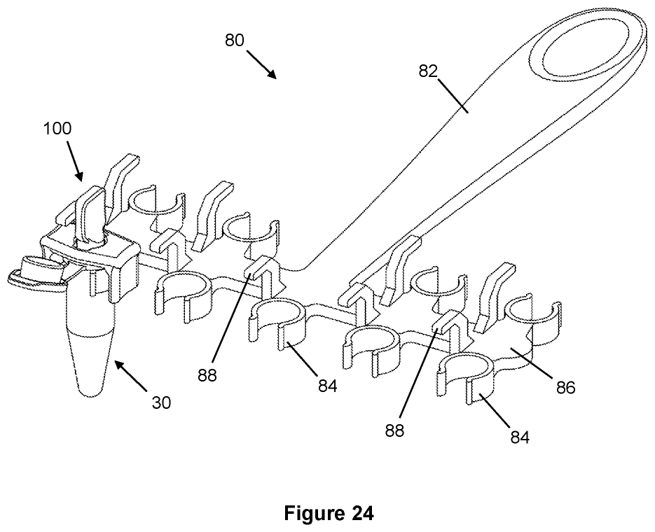

Finally, in practice, it may at times be desirable to manually agitate or invert a plurality of sample tubes 30/30′ simultaneously (with or without the present lid assembly 100 attached), to save time. To achieve this, FIG. 24 illustrates a handheld device 80 for holding a plurality of sample tubes 30/30′ and enabling them to be simultaneously manually agitated or inverted, without requiring electrical power. One such sample tube 30 is shown held in place, with the present lid assembly 100 attached.

More particularly, the device 80 comprises a handle part 82, and a plurality of sample tube retaining clips 84, each for holding a respective sample tube 30/30′. The plurality of retaining clips 84 are mounted on a cross-member 86 that extends perpendicular to, and either side of, the handle part 82.

The device 80 further comprises a plurality of restraining arms 88, each restraining arm 88 extending above a respective one of the retaining clips 84. The restraining arms 88 serve to prevent the sample tubes 80/80′ from falling out of the retaining clips 84 when the device 80 is inverted.

From FIG. 24 it will be appreciated that each restraining arm 88 is offset to one side of the respective retaining clip 84. This is in order to accommodate sample tubes 80/80′ to which the present lid assembly 100 is attached. By being offset in this manner (and with reference back to FIG. 1, for example), each restraining arm 88 does not foul the magnet-bearing part 10 (specifically the user-grippable part 13) of the lid assembly 100, but instead acts against the upper part 21 of the closure part 20, to one side of the magnet-bearing part 10.

The device 80, including the retaining clips 84 and the restraining arms 88, may be formed as a unitary structure from a plastics material, e.g. by injection moulding or 3D printing. Whilst the illustrated device 80 is shown as having the capacity to support nine sample tubes 80/80′, this is merely by way of example, and other numbers of retaining clips 84 and restraining arms 88 are of course possible.

Accordingly, the present disclosure also provides a manual method of simultaneously agitating or inverting a plurality of sample tubes 30/30′, comprising inserting the sample tubes 30/30′ into the device 80, and manipulating the handle part 82 to simultaneously agitate or invert the tubes. Optionally, at least one of the sample tubes may be attached to an above-described lid assembly 100. Also optionally, at least one of the sample tubes may be an above-described modified sample tube 30′. It will be appreciated that no electrical power is required to perform this manual method of simultaneously agitating or inverting the sample tubes 30/30′, thus rendering it suitable for use in remote field locations or low-resource settings.

1. A lid assembly for a sample tube, for collecting magnetic beads from the sample tube and subsequently releasing said beads, the lid assembly comprising:
a closure part including
an attachment part for removably attaching the closure part to the opening of the sample tube, to close the sample tube, and
a bead-collecting platform arranged to locate within or above the opening of the sample tube when the closure part is attached to the sample tube, wherein the bead-collecting platform has a bead-collecting surface on one side, for coming into contact with liquid in the sample tube during use, and a magnet-receiving cavity on the other side, behind the bead-collecting surface; and
a magnet-bearing part comprising a magnet, wherein the magnet is removably insertable into the magnet-receiving cavity, towards the bead-collecting surface, such that, when the magnet is present within the magnet-receiving cavity, the magnet is capable of holding magnetic beads against the bead-collecting surface, and when the magnet is not present within the magnet-receiving cavity, the lid assembly is incapable of magnetically holding magnetic beads against the bead-collecting surface.

2. The lid assembly according to claim 1, wherein the magnet-bearing part is separable from the closure part;
or wherein the magnet-bearing part is coupled to the closure part whilst permitting the magnet to be moved within the magnet-receiving cavity, towards or away from the bead-collecting surface.

3. (canceled)

4. The lid assembly according to claim 1, wherein the magnet-bearing part further comprises a user-grippable part to which the magnet is attached;
wherein the user-grippable part has a cross-sectional profile such as to enable it to act as a stand, for supporting the magnet-bearing part upside-down.

5. (canceled)

6. The lid assembly according to claim 1, wherein the magnet-receiving cavity is in the form of a socket shaped to receive at least the magnet of the magnet-bearing part;
optionally wherein the magnet-bearing part is rotatable within the socket,
optionally wherein the socket comprises gripping parts for gripping the magnet-bearing part.

7. (canceled)

8. The lid assembly according to claim 1, wherein the magnet-bearing part and the closure part are mutually engageable when the magnet is inserted into the magnet-receiving cavity;
optionally wherein the magnet-bearing part is rotatable within the socket, the magnet-bearing part comprises one or more radial protrusions and the socket comprises one or more complementary channels into which the one or more radial protrusions are engageable, or the magnet-bearing part and the socket comprise mutually-engageable threads.

9. (canceled)

10. (canceled)

11. (canceled)

12. The lid assembly according to claim 1, wherein the attachment part comprises a press-fit part adapted to engage with the opening of the sample tube.

13. The lid assembly according to claim 12, wherein the press-fit part is the bead-collecting platform.

14. The lid assembly according to claim 1, wherein the attachment part comprises a snap-fit mechanism.

15. The lid assembly according to claim 1, wherein the closure part, when viewed from above, has an elongate shape.

16. The lid assembly according to claim 1, wherein the closure part comprises first and second finger-tabs on opposite sides of the closure part, to enable it to be gripped by a user's thumb and finger in use;
optionally wherein the first and second finger-tabs extend below the bead-collecting surface and can act as a stand for supporting the lid assembly in an upright orientation when separated from the closure part;
optionally wherein the first and second finger-tabs extend above the bead-collecting surface and can act as a stand for supporting the lid assembly in an upside-down orientation;
optionally wherein the bead-collecting platform extends parallel to, and separate from, the first and second finger-tabs.

17. (canceled)

18. (canceled)

19. (canceled)

20. The lid assembly according to claim 1, wherein the bead-collecting surface incorporates a recessed or concave region;
or wherein the bead-collecting surface is convex;
or wherein the bead-collecting surface incorporates an array of depressions or recesses.

21. (canceled)

22. (canceled)

23. The lid assembly according to claim 1, wherein the bead-collecting surface incorporates a fluid wicking member.

24. A kit comprising a lid assembly according to claim 1, at least a first sample tube, and optionally a pipette, and/or a swab, and/or a further sample collection tube;
optionally wherein the kit has a plurality of sample tubes connected to each other, wherein a last of the sample tubes is optionally connected to its neighbouring sample tube by a frangible connection;
optionally wherein the first sample tube is preloaded with magnetic beads;
optionally wherein the kit further comprises a tray that incorporates one or more recesses or cavities for supporting the sample tube(s), and a recess on which the lid assembly can be placed, the tray thus serving as a stand for the tube(s) and providing a platform or drying area for the lid assembly.

25. (canceled)

26. (canceled)

27. The kit according to claim 1, having first, second and third sample tubes, wherein:
the first sample tube contains a lysis/binding buffer liquid;
the second sample tube contains a washing liquid; and
the third sample tube contains an elution liquid.

28. (canceled)

29. (canceled)

30. (canceled)

31. The kit according to claim 24, wherein at least one of the sample tubes has a closable cap, wherein the cap comprises a compartment containing a reagent, and wherein the compartment has a removable cover for sealing the reagent therein;
optionally wherein the compartment is on the inside of the cap, such that the compartment locates within the sample tube when the cap closes the sample tube;
optionally wherein the cap is attached to the sample tube by a flexible hinge;
optionally wherein the reagent is in the form of a bead, which may be press-fitted into the compartment;
optionally wherein the reagent is a detection reagent.

32. (canceled)

33. (canceled)

34. (canceled)

35. (canceled)

36. (canceled)

37. (canceled)

38. (canceled)

39. A method of collecting magnetic beads from a liquid within a sample tube, the method comprising:
attaching the closure part of a lid assembly according to claim 1, to the opening of the sample tube; and
agitating the liquid with the magnet inserted in the magnet-receiving cavity, such that the magnetic beads come into contact with the bead-collecting surface and are held by the magnet against the bead-collecting surface.

40. The method of claim 39, wherein the sample tube is a first sample tube containing a first liquid, and the method further comprises:
detaching the lid assembly from the first sample tube, with the magnet inserted in the magnet-receiving cavity and the magnetic beads held by the magnet against the bead-collecting surface;
attaching the closure part of the lid assembly to the opening of a second sample tube containing a second liquid; and
removing the magnet from the magnet-receiving cavity, such that the magnetic beads are no longer held by the magnet against the bead-collecting surface and become suspended in the second liquid.

41. The method of claim 40, further comprising:
reinserting the magnet in the magnet-receiving cavity;
agitating the second liquid such that the magnetic beads come into contact with the bead-collecting surface and are held by the magnet against the bead-collecting surface;
detaching the lid assembly from the second sample tube, with the magnet inserted in the magnet-receiving cavity and the magnetic beads held by the magnet against the bead-collecting surface;
attaching the closure part of the lid assembly to the opening of a third sample tube containing a third liquid; and
removing the magnet from the magnet-receiving cavity, such that the magnetic beads are no longer held by the magnet against the bead-collecting surface and become suspended in the third liquid.

42. The method of claim 41, further comprising:
reinserting the magnet in the magnet-receiving cavity;
agitating the third liquid such that the magnetic beads come into contact with the bead-collecting surface and are held by the magnet against the bead-collecting surface; and
detaching the lid assembly from the third sample tube, with the magnet inserted in the magnet-receiving cavity and the magnetic beads held by the magnet against the bead-collecting surface;
and optionally then disposing of the lid assembly and/or the magnetic beads.

43. The method of claim 41, for the extraction of targeted biomolecules, wherein:
the first liquid is a lysis/binding buffer liquid, for binding the biomolecules to the magnetic beads;
the second liquid is a washing liquid; and
the third liquid is an elution liquid, for eluting the biomolecules;
optionally wherein the targeted biomolecules comprise nucleic acid;
optionally wherein the method further comprises introducing a detection reagent into the elution liquid, and applying heating if necessary, to determine the presence or absence of the targeted biomolecules;
optionally wherein the third sample tube has a closable cap, the cap comprises a compartment containing the detection reagent, and the compartment has a removable cover for sealing the detection reagent therein, and wherein introducing the detection reagent comprises releasing it from the compartment of the third sample tube.

44-52. (canceled)
